(19) United States
(12) Patent Application Publication
(10) Pub. No.: US 2023/0410070 A1
(43) Pub. Date: Dec. 21, 2023

(54) CONTROLLING GAMING MOMENTS VIA GAMING SYSTEM(S)

(71) Applicant: LNW Gaming, Inc., Las Vegas, NV (US)

(72) Inventors: Sourabh SRIOM, Las Vegas, NV (US); Spandana MALREDDY, East Brunswick, NJ (US); Pinak Dineshbhai PATEL, Henderson, NV (US); Jayakumar BALAKRISHNAN, Chennai (IN); Mahalakshmi SABAPATHY, Tamil Nadu (IN); S. Prathap STALIN, Tamil Nadu (IN); Nageshwaran KANDASAMY, Tamil Nadu (IN); Venkata Sai Krishna Chaithanya PATNAM, Hyderabad (IN); Nilamben Gauravkumar LADANI, Karnataka (IN); Deepak KATHIRESAN, Tamil Nadu (IN); Chitra SURESH, Karnataka (IN); Damodaran RAMANI, Hayward, CA (US); Mohan Raj SUBRAMANI, Henderson, NV (US); Upasna VIG, Punjab (IN); Elamaran SUGUMAR, Mannargudi (IN); John G. KROECKEL, San Ramon, CA (US); Sreedhar RAMIREDDY, Pleasanton, CA (US); Rajendra Prasad Sreekanth ALUR, Kadapa (IN); Sudarshan MISE, Aurad(B) (IN); Anow Fanny DURAIRAJ, Chennai (IN); Vijay RAMACHANDRAN, Chennai (IN); Vijesh NARAYANAN, Chennai (IN); Nirmal Kumar VENUGOPAL, Thiruninravur (IN); Krishna Mohan SINHA, Bihar (IN); Arulkumar PALANISAMY, Tiruppur (IN); Siddarthan KRISHNAN ATCHAYAKUMAR, Chennai (IN); Sreeram RAMAMURTHY, Chennai (IN); Aditya JOSHI, Bangalore (IN); Balamurugan MURUGAIYAN, CHENNAI (IN); Arvind Kumar BOTHRA, Chennai (IN); Baskaran VENUGOPAL, Thiruvallur (IN); Divya SAMINATHAN, Thanjavur (IN); Tharmeeganathan ARUNACHALAM, Tamil Nadu (IN); Karun GOPINATH, Kerala (IN)

(21) Appl. No.: 18/337,976

(22) Filed: Jun. 20, 2023

Related U.S. Application Data
(60) Provisional application No. 63/354,135, filed on Jun. 21, 2022.

(51) Int. Cl. G06Q 20/12; G06Q 20/38; G07F 17/32

(52) U.S. Cl. CPC G06Q 20/123; G06Q 2220/10; G07F 17/3251; G06Q 20/389

(57) ABSTRACT

Systems and methods are provided for controlling gaming moments across different gaming channels, different entities, and different environments. In one example, the system and methods use blockchain and/or non-fungible token (NFT) components and/or functionality. In an embodiment, a computing system can detecting a qualifying game event for a sharable gaming moment. The computing system generates a digital asset. The digital asset indicates details of the qualifying game event. The computing system encodes a referral code with the digital asset. The computing system transmits, in response to a user input via an application of a user computing device, the digital asset and the referral code to at least one gaming channel. The computing system detects, in response to electronic communication from the at least one gaming channel, an action associated with the digital asset. The computing system awards, based on the referral code and the action, a number of points for use (e.g., via the gaming system or other gaming device).

### RELATED APPLICATIONS

This patent application claims priority benefit to U.S. Provisional Patent Application No. 63/354,145 filed Jun. 21, 2022. The 63/354,145 Application is hereby incorporated by reference herein in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023, LNW Gaming, Inc.

### FIELD

The present disclosure relates to integrated computer-implemented gaming systems, digital ledger systems, and metaverse systems.

### BACKGROUND

Conventional gaming systems include many different types of games that are provided to users through a variety of different gaming channels. For instance, wagering game machines, such as slot machines, video poker machines and the like, have been a central part of the gaming industry for several years. Generally, the popularity of such machines depends on the likelihood (or perceived likelihood) of winning money or other awards of value at the machine and the intrinsic entertainment value of the machine relative to other available gaming options. In some cases, the perceived likelihood of winning something of value at a machine may be based on the amount of trust users place in the machine and machine operator.

With the prevalence of a wide variety of gaming systems being available over numerous gaming channels, a number of systems have been proposed to provide improvements to user gaming experiences. For example, some systems allow users to earn rewards in association with gameplay associated with a user account or reward card. These rewards can be applied to future physical and/or online gameplay or used to redeem other items of value. Some of these systems allows users to track their gameplay so they can view historical activity across a gaming channel.

While traditional systems seek to increase user engagement through new and interesting games, loyalty clubs, and the like, these systems are typically brand-specific and limited to a single gaming channel. A user wishing to redeem or apply a reward is often limited in their ability to do so. For example, there may be use restrictions limiting redemption to certain parties or at particular locations. Moreover, many of these systems do not provide transferrable instruments nor the ability to record information relating to rewards and/or redemptions.

### BRIEF DESCRIPTION OF THE DRAWINGS

Detailed discussion of embodiments directed to one of ordinary skill in the art are set forth in the specification, which makes reference to the appended figures, in which:

FIG. 1 is a diagram depicting an example gaming system 100 including a blockchain platform in accordance with example embodiments of the present disclosure;

FIG. 2 is a flow diagram illustrating moment control operations in accordance with example embodiments of the present disclosure;

FIG. 3 is a flow diagram illustrating creating and customizing a digital asset in accordance with example embodiments of the present disclosure;

FIG. 4A is a diagram depicting an architecture in accordance with example embodiments of the present disclosure;

FIG. 4B is a diagram depicting an architecture in accordance with example embodiments of the present disclosure;

FIG. 5A, 5B, and 5C are diagrams depicting moment capture devices in accordance with example embodiments of the present disclosure;

FIGS. 6A and 6B are diagrams depicting moment capture architectures in accordance with example embodiments of the present disclosure;

FIGS. 7A and 7B are diagrams depicting creation of gaming moments in accordance with example embodiments of the present disclosure;

FIG. 8 is a diagram depicting customization of a digital asset in accordance with example embodiments of the present disclosure;

FIG. 9A, 9B, and 9C are diagrams depicting purchasing digital assets in accordance with example embodiments of the present disclosure;

FIG. 10 is a flow diagram illustrating associating a referral code with a digital asset and tracking usage of the referral code in accordance with example embodiments of the present disclosure;

FIGS. 11A and 11B are diagrams depicting generation and sharing of referral codes in accordance with example embodiments of the present disclosure;

FIGS. 12A and 12B are diagrams depicting generating and sharing of moments with associated referral codes in accordance with example embodiments of the present disclosure;

FIG. 13 is a diagram depicting posting moments and awarding a patron in accordance with example embodiments of the present disclosure;

FIG. 14 is a flow diagram illustrating moment control operations and awards for an NFT in accordance with example embodiments of the present disclosure;

FIG. 15 is a flow diagram illustrating creating a game moment NFT and awarding NFT actions in accordance with example embodiments of the present disclosure;

FIG. 16 is a flow diagram illustrating moment streaming and awarding in accordance with example embodiments of the present disclosure;

FIG. 17 is a flow diagram illustrating livestreaming a game moment and awarding points in accordance with example embodiments of the present disclosure;

FIG. 18 is a diagram depicting a system in accordance with example embodiments of the present disclosure;

FIG. 19 is a diagram illustrating targeting content presentation in a casino environment in accordance with example embodiments of the present disclosure;

FIG. 20 is a diagram depicting targeting casino presentation devices based on content type in accordance with example embodiments of the present disclosure;

FIG. 21A, 21B, and 21C are flow diagrams illustrating targeted marketing via a network of casino presentation devices in accordance with example embodiments of the present disclosure;

FIG. 22A, 22B, and 22C are flow diagrams illustrating targeted casino operational content via a network of casino presentation devices in accordance with example embodiments of the present disclosure;

FIG. 23 is a schematic view of a gaming system in accordance with example embodiments of the present disclosure.

FIG. 24 is a diagram of a computer system in accordance with example embodiments of the present disclosure.

FIG. 25 is a diagram depicting purchasing digital assets in accordance with example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

In general, embodiments in accordance with the present disclosure are directed to systems and methods that enable gaming solutions across multiple gaming channels (e.g., intra-casino gaming channels, external gaming channels, social media channels, etc.) using digital assets, non-fungible tokens (NFTs), and a blockchain infrastructure. Digital assets and/or NFTs can be actioned to players in a gaming computing environment through one or more of the gaming channels. Gaming channels, blockchain infrastructure, NFT marketplaces, and the like, are described in detail in U.S. Patent Application No. 63/306,226 filed Feb. 3, 2022, which is incorporated by reference herein in its entirety.

By way of example, one aspect of the present disclosure provides an NFT portal (also referred to as NFT marketplace) that enables users to purchase NFTs that may have a limited supply. The NFTs may be actioned by or for a user within one or more gaming channels of the gaming system. For instance, the user may pair with a particular gaming channel using a cross-channel application. The cross-channel application may enable traditional digital wallet and/or crypto wallet functionalities such as making payments in traditional currency and/or cryptocurrency and/or managing NFT assets. Additionally, the cross-channel application can facilitate NFT interaction within multiple different gaming channels of a gaming computing environment.

According to one example aspect of the present disclosure, a gaming system can include a plurality of gaming channels. In some examples, one or more of the gaming channels are associated with at least one channel server. For example, an online gaming channel can include an online game that is hosted on one or more host channel servers. One or more intermediary servers communicate with the various channel servers to action NFTs across the various gaming channels. The intermediary server(s) may provide personalization data based on NFT data received from the digital ledger platform. In another example, the NFT data may be provided to the gaming channel which can generate a personalized user experience directly based on the NFT data. A user device can interface with one or more of the gaming channels via a cross-channel application that enables customizing digital assets (e.g., for NFT creation), sharing digital assets (e.g., posting gaming moments via a social network system, streaming the digital asset to a gaming server, minting an NFT from the digital asset and making it available via an NFT marketplace, etc.), providing NFT functionality across the different gaming channels (e.g., NFT/smart-contract actions resulting in gaming features and/or benefits), associating referral codes with the digital asset, awarding a player account points based on the detected use of the referral codes, etc.

The gaming system can further include a digital ledger platform to support NFT functionality across the various gaming channels. The digital ledger platform can include one or more digital ledgers to record transactions associated with NFTs of the gaming system and optionally one or more smart contracts associated with certain ones of the NFTs. The smart contracts can execute a machine-readable contract or agreement in association with one or more of the NFTs. For instance, the smart contract may define a first set of rewards in association with ownership of the NFT. The first set of rewards may be associated with the NFT being in a first state after having initially being purchased or awarded. The smart contract may define a second set of player rewards in association with the NFT being in a second state. For example, the smart contract may define that a certain number of hours of play (or other use) in association with the NFT or a certain level achieved in gameplay while displaying the NFT result in the NFT being in or otherwise associated with a second state. As a result of the associated awards, the NFT may have a different perceived value based on its associated state. The first player may elect to transfer all or partial ownership in the NFT to a second individual. In some instances, a smart contract may further specify automated actions to occur upon transfer. For example, the smart contract may specify a fee to be paid to a third party (e.g., the NFT issuer) by one or more of the transferring parties if an ownership interest in the NFT is sold.

As referenced herein, the term “player” refers to an entity such as, for example, a human, a user, an end-user, a consumer, an organization (e.g., a company), a computing device and/or program (e.g., a processor, computing hardware and/or software, an application, etc.), an agent, a machine learning (ML) and/or artificial intelligence (AI) algorithm, model, system, and/or application, and/or another type of entity that can implement one or more embodiments of the present disclosure as described herein, illustrated in the accompanying drawings, and/or included in the appended claims. As referenced herein, the terms “or” and “and/or” are generally intended to be inclusive, that is (i.e.), “A or B” or “A and/or B” are each intended to mean “A or B or both.” As referred to herein, the terms “first,” “second,” “third,” etc. can be used interchangeably to distinguish one component or entity from another and are not intended to signify location, functionality, or importance of the individual components or entities. As used herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling, etc.), mechanical coupling, operative coupling, optical coupling, and/or physical coupling.

Additional and/or alternative example aspects of the present disclosure are generally directed to one or more computing systems and/or methods (e.g., computer-implemented methods) that can facilitate associating a non-fungible token (NFT) with a player associated with a gaming environment. For instance, in example embodiments, a computing system described herein can associate the player's identity (e.g., the player's account identification data) with the digital asset identification data of an NFT. In some embodiments, the computing system can codify and/or manifest such an association of the player with the NFT in the form of, for example, an identification code (e.g., a quick response (QR) code) that can include data (e.g., encrypted data) that is descriptive of the association between the player and the NFT. In these or other embodiments, the computing system can provide such an identification code (e.g., a QR code) to the player (e.g., via the above-described cross-channel application) such that the player can use the identification code to implement one or more operations in the gaming environment according to one or more example embodiments described herein. In this manner, any or all rights and/or privileges of the player with respect to the NFT and/or the gaming environment can be represented and/or encapsulated by the identification code such that the identification code can provide the player with an NFT enabled gaming experience in the gaming environment according to one or more example embodiments of the present disclosure.

According to example embodiments of the present disclosure, a computing system such as, for instance, a computing system in a computer-based gaming environment having integrated digital ledger components and/or functionality, can associate an NFT with a player associated with a gaming environment. To facilitate such association of the NFT with the player, the computing system can include, be coupled to (e.g., communicatively, operatively, etc.), and/or otherwise be associated with one or more processors and/or one or more one or more non-transitory computer-readable storage media that can store instructions that, when executed by the one or more processors, can cause the computing system (e.g., via the one or more processors) to perform operations in accordance with one or more example embodiments described herein.

In one or more embodiments described herein, based at least in part on (e.g., in response to) receipt of such data indicating the NFT is to be actioned to the player, the computing system can generate identification data that associates the NFT with the player, where the identification data can include and/or constitute embedded data descriptive of the player and the NFT. For example, in at least one embodiment, the identification data and/or the embedded data descriptive of the player and the NFT can include and/or constitute: identity data descriptive of the player (e.g., player's name, username, gaming identification number, telephone number, e-mail address, etc.); data descriptive of a player and/or a user account associated with the gaming environment that can correspond to the player (e.g., player's account identification data, telephone number, e-mail address, etc.); data descriptive of a digital wallet of the player (e.g., a traditional digital wallet, a crypto wallet, etc.); digital asset identification data corresponding to the NFT; data descriptive of an identifier corresponding to the NFT, where the identifier can include and/or constitute data indicative of a storage location where the NFT is stored (e.g., the identifier can include and/or constitute a pointer and/or a computer program object having a memory address where the NFT is stored); and/or other data descriptive of the player and the NFT. In some embodiments, the computing system can encrypt and/or otherwise encode the above-described identification data and/or embedded data descriptive of the player and the NFT such that the data is protected and/or secured from interception, viewing, and/or use by one or more unintended third-parties.

According to one or more embodiments of the present disclosure, the computing system can provide the above-described identification code to the player. For example, in these one or more embodiments, based at least in part on (e.g., in response to) creating the identification code, the computing system can provide the identification code to the player via, for instance, a network (e.g., a wide area network (WAN), a local area network (LAN), the Internet, etc.) and/or the cross-channel application described above that can be installed on and/or executed on a computing device (e.g., a smart phone, laptop, tablet, etc.) associated with the player.

In at least one example embodiment, upon receiving confirmation of the player's receipt and/or acceptance of the identification code, the computing system can store data descriptive of the association of the player with the digital asset and/or NFT on the above-described one or more non-transitory computer-readable storage media that can be included in, coupled to, and/or otherwise associated with the computing system. For example, in this or another example embodiment, the computing system can store, on such one or more non-transitory computer-readable storage media, data that can include, for instance: data descriptive of the identification code; data descriptive of the identification data; data descriptive of the above-described embedded data descriptive of the player and the digital asset and/or NFT; data descriptive of the digital asset and/or NFT (e.g., digital asset identification data); and/or other data that can reflect the association of the player with the digital asset and/or NFT. In another embodiment, the computing system can store the digital asset and/or NFT itself and/or data indicative of the location of the digital asset and/or NFT (e.g., the above-described identifier and/or pointer) on such one or more non-transitory computer storage media that can be included in, coupled to, and/or otherwise associated with the computing system.

Additional and/or alternative example aspects of the present disclosure are generally directed to one or more computing systems and/or methods (e.g., computer-implemented methods) that can facilitate integration of digital asset and/or NFT and/or metaverse components and/or functionality in a gaming environment to provide a player with a borderless, boundaryless, and interleaved real-virtual world gaming experience across different gaming channels, different entities (e.g., different gaming organizations, different casinos, different product and/or service providers, etc.), and/or different environments (e.g., different gaming environments, different physical real-world environments, different computer-based environments, etc.). For instance, in example embodiments, a computing system described herein can sync, couple, and/or otherwise associate a metaverse gaming device of a metaverse gaming environment (e.g., a virtual and/or digital gaming device that can be implemented in a metaverse gaming environment) with a physical gaming device of a physical gaming environment (e.g., a real gaming device and/or a real gaming table that can be implemented in a physical gaming environment such as, for instance, a casino). For example, the computing system can sync, couple, and/or otherwise associate the metaverse gaming device with the physical gaming device such that one or more activities and/or operations associated with one of such devices is also associated with the other device. As an example, in one embodiment, the computing system can sync, couple, and/or otherwise associate the metaverse gaming device with the physical gaming device such that an outcome of a gameplay executed via the physical gaming device in the physical gaming environment can also be the outcome of the gameplay that can be output (e.g., simultaneously, in real-time) by the metaverse gaming device in the metaverse gaming environment.

In one embodiment, the physical gaming device can constitute, include, be coupled to, and/or otherwise be associated with an electronic and/or computer-based gaming device such as, for example, an electronic gaming machine (EGM), an electronic table game (ETG), and/or another electronic and/or computer-based gaming device that can be physically located in a physical gaming environment such as, for instance, a casino. In this embodiment, the metaverse gaming device can constitute and/or include application software (e.g., computer-readable instructions) such as, for example, an application instance, an application object, a system image, a virtual machine, and/or other application software that can be implemented in the metaverse gaming environment and synced with, coupled to, and/or otherwise correspond to the physical gaming device. For instance, in this embodiment, the metaverse gaming device can constitute and/or include such application software (e.g., application instance, application object, system image, virtual machine, etc.) that can be synced with, coupled to, and/or otherwise correspond to the physical gaming device such that the application software can constitute a virtual and/or digital representation of the physical gaming device in the metaverse gaming environment.

In another embodiment, the physical gaming device can constitute, include, be coupled to, and/or otherwise be associated with a real, physical table game (e.g., poker table, blackjack table, roulette table, etc.) that can be physically located in a physical gaming environment such as, for instance, a casino. In this embodiment, the physical gaming device can constitute, include, be coupled to, and/or otherwise be associated with a computing device (e.g., a special-purpose computer or general-purpose computer) that can be physically located in the physical gaming environment and/or another environment and can perform one or more operations associated with the physical gaming device. For instance, in one embodiment, the computing device can provide output data that can include and/or constitute instructions associated with executing a game and/or a gameplay via the physical gaming device (e.g., the computing device can provide output data that is descriptive of which card(s) a gaming dealer should deal to one or more players participating in the game and/or gameplay). In another example embodiment, the computing device can receive input data that can be descriptive of one or more activities and/or events associated with the physical gaming device. For example, in one embodiment, the computing device can receive input data that can be descriptive of an outcome (e.g., win, loss, tie, etc.) of a game and/or a gameplay that can be implemented via the physical gaming device in the physical gaming environment. In one or more embodiments, the computing device can store, communicate, and/or otherwise manage the above-described output and/or input data.

In multiple embodiments of the present disclosure, the metaverse gaming device and/or the above-described application software can include and/or constitute a virtual and/or digital representation of one or more attributes (e.g., featured game(s), graphical user interface(s), etc.), structural components (e.g., cabinet housing, primary game display, etc.), and/or functionality of the physical gaming device. In one or more other example embodiments where the physical gaming device is a real, physical table game such as, for instance, a blackjack table, the metaverse gaming device and/or the above-described application software can include and/or constitute a virtual and/or digital representation of one or more attributes, structural components, and/or functionality of the blackjack table (e.g., table design, size, shape, color, number of player positions, player seat design, etc.).

In at least one example embodiment of the present disclosure, the computing system can associate the above-described outcome of the gameplay with a digital asset and/or an NFT. In one embodiment, the computing system can associate the outcome with a digital asset and/or an NFT by creating and/or defining a machine-readable contract such as, for instance, a smart contract as described herein that can include data that is descriptive of the outcome, the identity of the outcome, and the identity of the NFT. In this or another embodiment, the smart contract can further include pre-defined terms and/or conditions corresponding to the outcome and/or the NFT. In this or another embodiment, the computing system can create and/or define the smart contract such that it includes digital asset identification data of the NFT that the smart contract and/or the pre-defined terms and/or conditions thereof can associate with data descriptive of the outcome and/or the identity of the outcome.

In at least one embodiment, the computing system can create and/or define the above-described smart contract and/or the pre-defined terms and/or conditions thereof such that they specify certain data that can be associated with an operator of a gaming environment having a gaming device that executed the game session, where such data can be rendered with (e.g., overlaid on) the game session content when shared and/or recreated via a local and/or remote device. For example, in this or another embodiment, such data can include and/or constitute data that can be descriptive of, for instance: the name of the gaming environment operator (e.g., casino name); location of the gaming environment (e.g., city, state, jurisdiction, etc.); date and/or time the game session was played; credits won; bonus and/or progressive associated with the game session (e.g., triple sevens, jackpot win, mega progressive hit, etc.); and/or other data that can be associated with the gaming environment operator that can be rendered with (e.g., overlaid on) the game session content when shared and/or recreated via a local and/or remote device.

In at least one embodiment, the percentage of such a token (e.g., a fungible token), digital asset, and/or crypto asset (e.g., a crypto currency, crypto coin, etc.) that can be earned by the player in return for participating in the game as described above can be converted to, for example, a game credit(s) and/or local currency (e.g., real currency (e.g., United States dollar), currency issued by an operator of the gaming environment, etc.). In one embodiment, the percentage of such a token (e.g., a fungible token), digital asset, and/or crypto asset (e.g., a crypto currency, crypto coin, etc.) can be transferred to an account (e.g., the player's gaming account associated with the gaming environment) and/or digital wallet associated with the player. In another embodiment, the percentage of such a token (e.g., a fungible token), digital asset, and/or crypto asset (e.g., a crypto currency, crypto coin, etc.) that can be earned by the player in return for participating in the game as described above can include and/or constitute one or more crypto rewards.

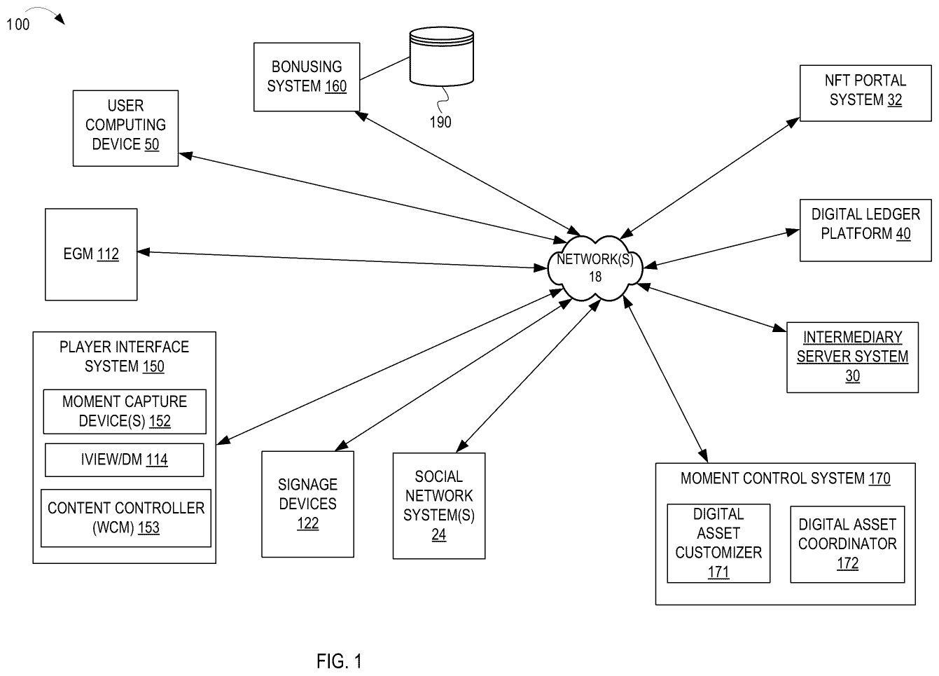

FIG. 1 is a diagram depicting an example gaming system 100 including a blockchain platform in accordance with example embodiments of the present disclosure. The gaming system 100 includes a plurality of computing devices that are communicatively coupled over one or more networks 18. In this example, the computing devices include one or more gaming channel systems (e.g. moment control system 170, EGM 112, bonusing system 160, player interface system 150, signage devices 122, social network system(s) 24, an intermediary server system 30, etc.). The computing devices further include additional systems and/or devices including a non-fungible token (NFT) portal system 32, a digital ledger platform 40 and a user computing device 50. Although shown separately, various elements of FIG. 1 may be combined. For example, the NFT portal system 32, intermediary server system 30, and/or dApp systems can be part of the digital ledger platform 40 in example embodiments. Computing environment 100 is one example of a computer gaming environment. The number and type of computing devices in the computing systems of FIG. 1 are depicted by way of example only. For example, other computing environments may include additional user computing devices 50, fewer or additional gaming channel systems, etc. than those depicted in FIG. 1. It will be appreciated that the system of FIG. 1 is provided by way of example and not limitation as other computing systems may be used in accordance with example embodiments of the present disclosure.

The user computing device 50 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

Gaming channel systems can include, but are not limited to, a physical gaming system (e.g., electronic gaming machine (EGM) 112), a player interface system 150, signage devices 122, a bonusing system 160, a moment control system 170, one or more social network systems 24, etc. The number and type of gaming systems in FIG. 1 is provided by way of example only. For example, physical gaming systems may represent a single electronic gaming machine (EGM) at a gaming location (e.g., EGM 112) or multiple EGM's and/or associated computing devices such as one or more physical gaming servers that support the EGMs or client devices. Social network system(s) 24 may represent a user device executing a local client application and/or server device providing an online social network service. In some example embodiments, the various gaming channel devices may be under control and operation by a single entity such as a gaming operator. In other examples, the gaming channel systems may be under the control of multiple different entities. For example, a first gaming entity may operate a physical gaming server while a different gaming entity may operate a lottery server or online gaming server.

Digital ledger platform 40 can include one or more computing devices that provide a digital ledger infrastructure in association with gaming channel systems. Digital ledger platform 40 enables numerous different non-fungible tokens (NFT) to be actioned across one or more of the gaming channel systems. Moreover, digital ledger platform 40 supports cross-channel actioning of NFTs to enable NFTs to be used in and across different gaming channels. Digital ledger platform 40 includes a physical layer comprising one or more computing devices (e.g., a server system, distributed peer-to-peer network, etc.), a digital ledger layer comprising one or more digital ledgers, one or more smart contracts, distributed application (dAPP) systems, an API layer comprising one or more APIs for accessing elements of the ledger platform such as smart contracts, and a ledger explorer.

A digital ledger, as that term is used herein, refers to all forms of electronic, computer-based, distributed ledgers. Examples of digital ledgers include consensus-based blockchain and transaction-chain technologies, permissioned and un-permissioned ledgers, shared ledgers and variations thereof. A blockchain is a peer-to-peer, digital ledger implemented as a decentralized, distributed computer-implemented system. A blockchain architecture enables different users to make transactions and creates an unchangeable record of those transactions.

A digital ledger layer of the digital ledger platform 40 may be used for the implementation of or otherwise in association with one or more smart contracts. By way of example, the digital ledger platform 40 may provide one or more virtual machines hosted by the physical layer that are configured to generate and/or manage smart contracts. A smart contract is a computer program that automates the execution of the terms of a machine-readable contract or agreement. A smart contract is a machine executable program including rules that process inputs in order to produce results. The results of processed inputs can cause actions to be performed dependent upon those results. By way of example, a commercial transaction may involve the transfer of property rights and/or assets. Such assets may include real property, personal property including both tangible and intangible property, digital assets such as software, for example, or any other type of asset. Smart contracts can provide enhanced control, efficiency, and speed of transfer for these transactions.

Smart contracts can be written to one or more blockchains of the digital ledger layer such that the smart contracts are immutable. The inputs to a smart contract can be formatted to include the data structures defined by the blockchain. A smart contract can accept inputs extracted from the transactions within the digital ledgers to automatically perform one or more predefined functions.

By way of example, a smart contract may be used to determine whether pre-determined conditions are met that prove an entity owns an NFT and has authority to transfer ownership. Smart contracts may require one or more sets of inputs to trigger a transaction. The inputs can be formatted to include data structures defined by the blockchain. The smart contracts can accept inputs extracted from transactions within the digital ledgers. A smart contract may be written in any suitable programming language, such as various programming languages based on If-This-Then-That (IFTTT) logic. A smart contract can be published or otherwise employed to enable cross-channel NFT actions as described herein.

A token within the digital ledger platform 40 can be used to represent and transfer assets via a digital ledger. A token can identify a real-world digital item or asset to be referenced from the digital ledger. Tokens may be fungible or non-fungible. A fungible unit is equivalent to and interchangeable with other units of the same commodity. Fungible tokens (FTs) are tokens that can be exchanged for any other token with the same value. A token can have various potential formats such as unique character string, a value, a pointer, an address, etc. A token can include an identifier such as an address or link to information maintained in non-volatile storage.

Nonfungible tokens (NFTs) are not replaceable with other tokens of the same type. NFTs represent nonfungible assets. Nonfungible assets have unique information or attributes. Each NFT is unique and differs from other tokens of the same class. For example, two concert tickets may appear similar, but each may have attributes or properties that render it irreplaceable by another concert ticket. Each concert ticket may have a different seat number and date which causes it to be unique from other concert tickets. Additionally, NFTs cannot be divided as the elementary unit of the NFT is the token itself.

Intermediary server system 30 includes one or more computing devices that communicate with digital ledger platform 40 and gaming channel systems to enable token services across the various gaming channels. In some embodiments, the intermediary server system 30 may include one or more computing devices operating within the physical layer of the digital ledger platform 40. For example, intermediary server system may include one or more nodes of the physical layer. In another example, intermediary server system 30 may include a partial node of the digital ledger platform. A “partial node” in this context is a computing device that monitors at least some transactions within the digital ledger platform but does not verify or authenticate the monitored transactions through mining. NFT portal system 32 includes one or more computing devices that provide an access point to NFTs provided by the gaming system. For example, a user can use a user computing device 50 to access a website or application hosted by the NFT portal system 32 in order to purchase, sell, or otherwise engage in transactions in association with NFTs provided by the gaming system. NFT portal system 32 may connect to digital ledger platform 40 over one or more communication channels which may be secured using authentication and/or encryption. In some examples, NFT portal system 32 can access one or more APIs to read data from the digital ledger platform.

The network 18 can be any type of communications network, such as a local area network (e.g., intranet), wide area network (e.g., Internet), or some combination thereof and can include any number of wired or wireless links. In general, communication over the network 18 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some embodiments, the moment control system 170 is configured to detect (e.g., via the user computing device 50, the EGM 112, the player interface system 150, etc.) one or more qualifying game events (e.g., wins above a threshold amount). The moment control system 170 is further configured to generate a digital asset commemorating the one or more events (e.g., a video, a stream, an image, etc.). The digital asset represents a gaming moment associated with a user. The moment control system 170 is further configured to customize (e.g., via a digital asset customizer 171) the digital asset based on user input. The moment control system 170 is further configured to coordinate (via digital asset coordinator 172) actions associated with of the use of the digital asset (e.g., transmissions of the digital asset via gaming channels, managing a change of ownership or benefits of the digital asset, tracking referral codes and use of the codes via various gaming channels (e.g., via social network system(s) 24), awarding points for the actions associated with the digital asset, etc.). In some embodiments, the moment control system 170 in included in, or is associated with, the intermediary server system 30.

The EGM 112 is configured to detect a qualifying game event for a moment and notify the user, such as via the EGM 112, the player interface system 150 (e.g., via iView/DM 114), via signage devices 122, etc. In some embodiments, the user computing device 50 is configured to present a digital asset for the moment via a cross-channel application. The user computing device 50 is further configured to receive and respond to user input related to the digital asset (e.g., user input to create, customize, share, mint, etc.). In some embodiments, the player interface system 150 includes one or more moment capture devices (moment capture device(s) 152). The moment capture device(s) 152 may include cameras, microphones, etc. to generate capture data, such as environmental images and/or sounds, images of the player's reactions to the event, etc. The player interface system 150 further includes a content controller 153 that generates content for the iView/DM 114 as well as content for the digital asset.

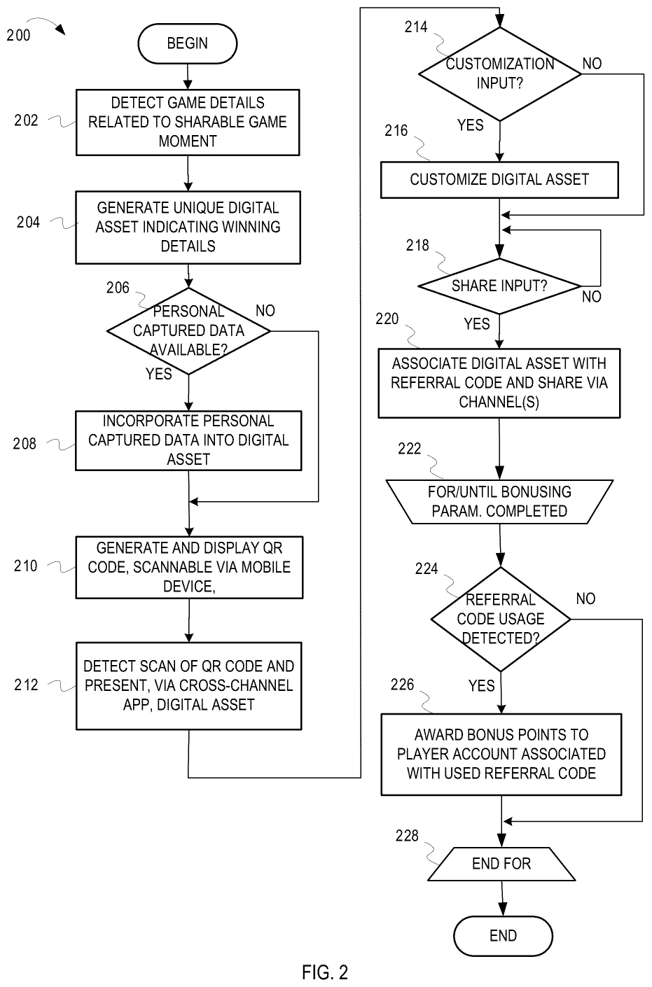

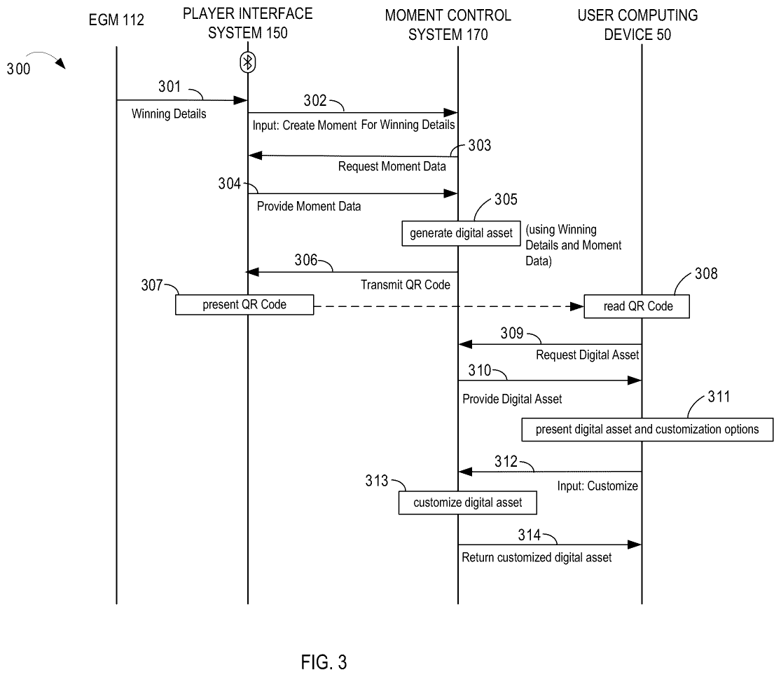

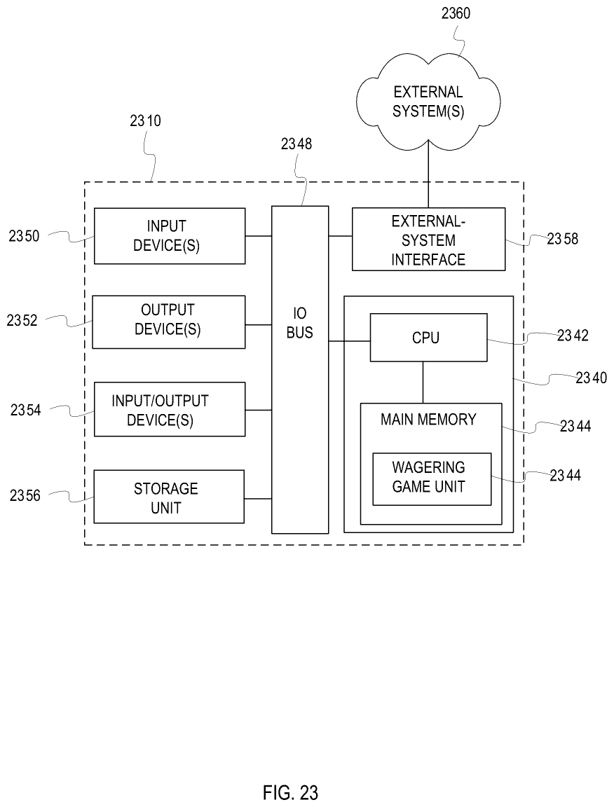

FIG. 2 is a flow diagram of a flow 200 illustrating moment control operations in accordance with example embodiments of the present disclosure. FIG. 3, 4A, 4B, 5A, 5C, 6A, 6B, 7A, 7B, 8, 9A, 9B, 9C, 10, 11A, 11B, 12A, 12B, 13, 14, 15, 16, 17, and are diagrams of an exemplary gaming system associated with the data flow shown in FIG. 3 according to one or more embodiments of the present disclosure. FIG. 3, 4A, 4B, 5B, 5C, 6A, 6B, 7A, 7B, 8, 9A, 9B, 9C, 10, 11A, 11B, 12A, 12B, 13, 14, 15, 16, 17, and 25 will be referenced in the description of FIG. 3. Furthermore, the flow 200 will refer to a processor. It should be noted that the reference to the processor may refer to the same physical processor or it may be one of a set of a plurality of processors. The set of processors may operate in conjunction with each other and may be distributed across various networked devices (e.g., across the gaming system 100). The types of processors may include a central processing unit, a graphics processing unit, any combination of processors, etc. In one embodiment, the processor may refer to the central processing unit (CPU) 2342 (FIG. 23) or a processor in another device mentioned herein, such as a processor associated with a table controller, a card-handling device, a camera controller, a game controller, a gaming server etc.

Referring to FIG. 2, the flow 200 begins at processing block 202 where a processor detects game details related to a sharable game moment. In some embodiments, the processor may detect one of a number of qualifying game events (e.g., wins, wins above a threshold, near wins, bonus events, etc.) that would be notable for a user (e.g., a player, a casino employee, etc.) to share. The phrases “moment” or “gaming moment,” refers to a qualifying game event that is recorded for sharing (including the underlying content, such as a digital asset). The digital asset for the moment (i.e., the digital content that depicts and/or describes the moment) is the unique digital representation of the moment. In some embodiments the processor detects the occurrence of the underlying game event by accessing event logs, such as those generated via the slot account system (SAS) protocol for automated meter reporting, event logging, player tracking, bonusing, ticketing, etc. For example, the EGM 112 may provide the event data to the player interface system 150 directly (e.g., via a software configuration for the game that reports the data directly to the player interface system 150), or the player interface system 150 may obtain the event data indirectly (e.g., reading SAS communication/logs).

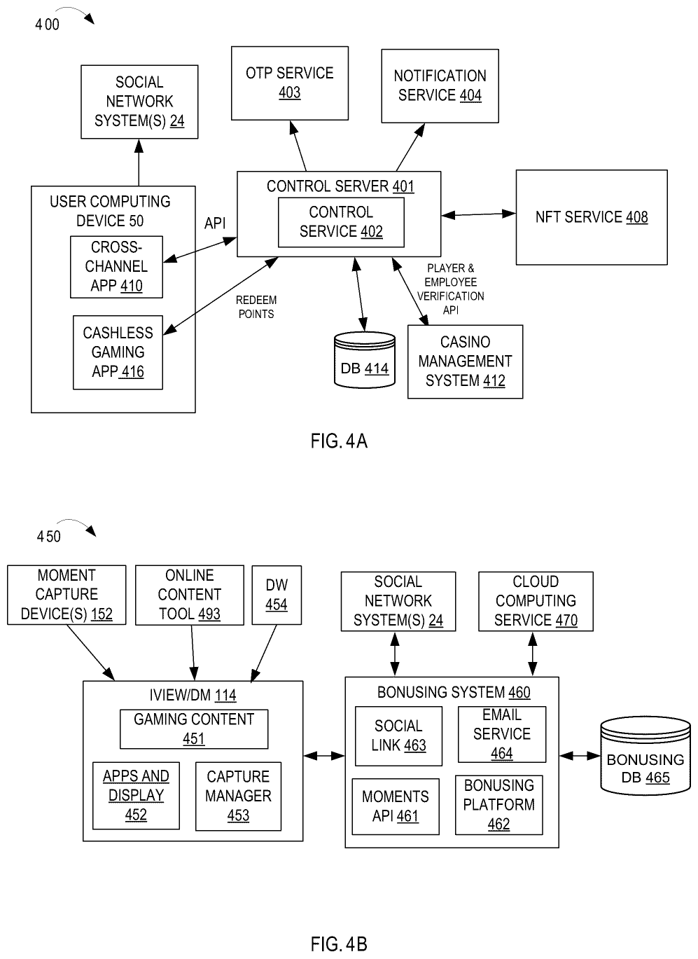

In some embodiments, the content from the game is configured to specify which source to capture from and/or which region from the source to record. In one embodiment, a tool is provided (e.g., via capture manager 453 in FIG. 4) for a user (e.g., a casino employee, a player, etc.) to specify a capture region (i.e., area of game, area of gaming environment, etc.) to capture for moment recording. In some embodiments, the areas that are specified can be stored in templates, which can be used for generation of digital assets (e.g., see processing block 204).

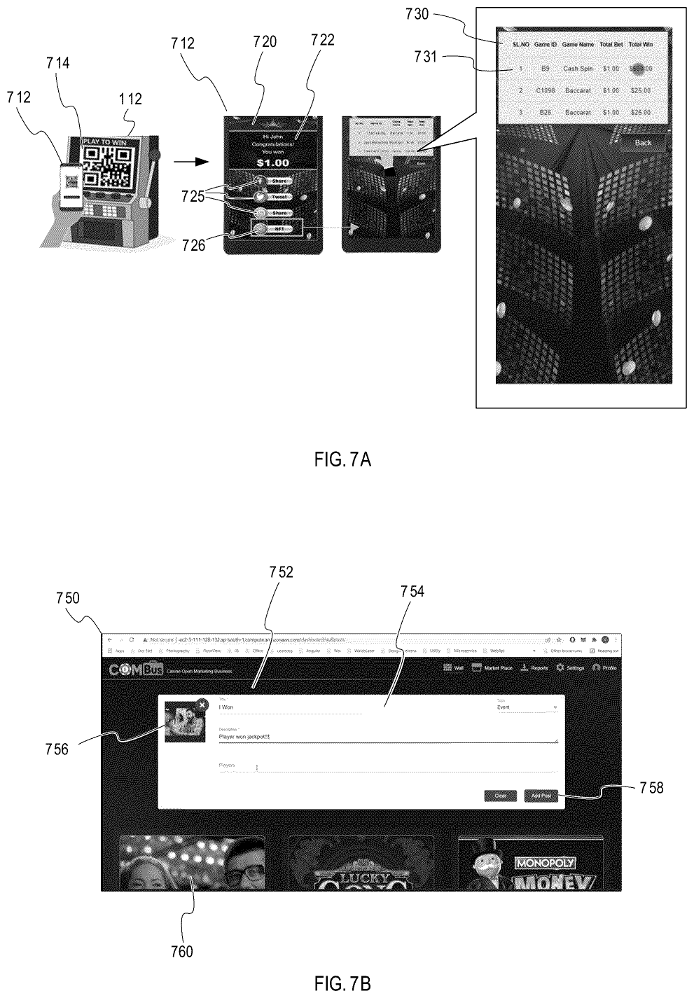

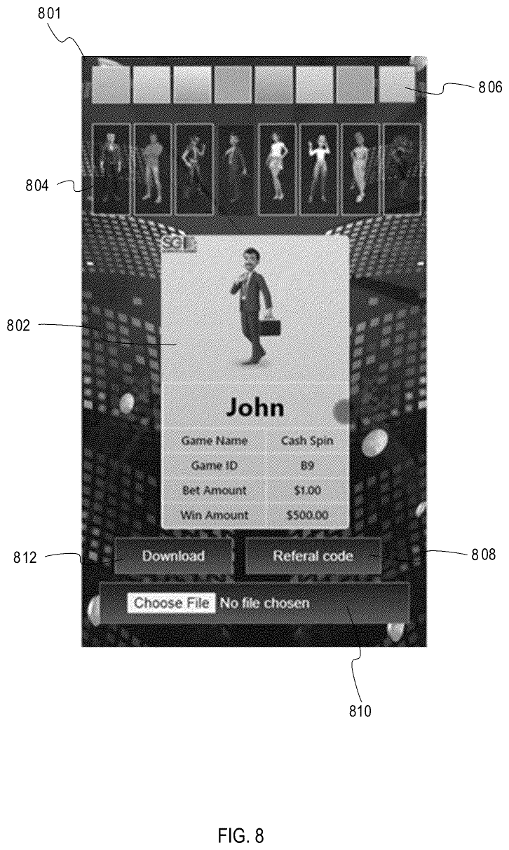

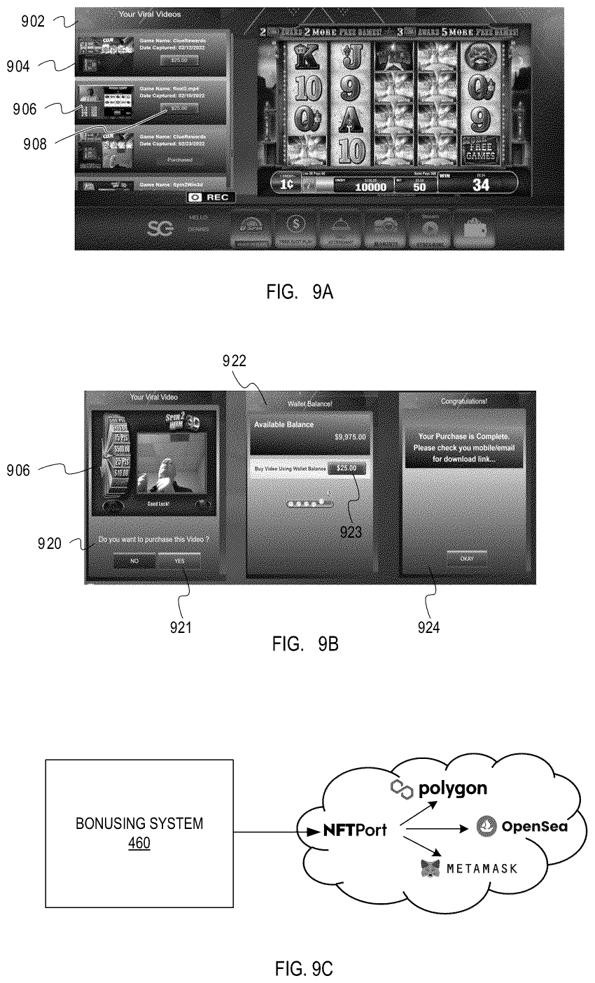

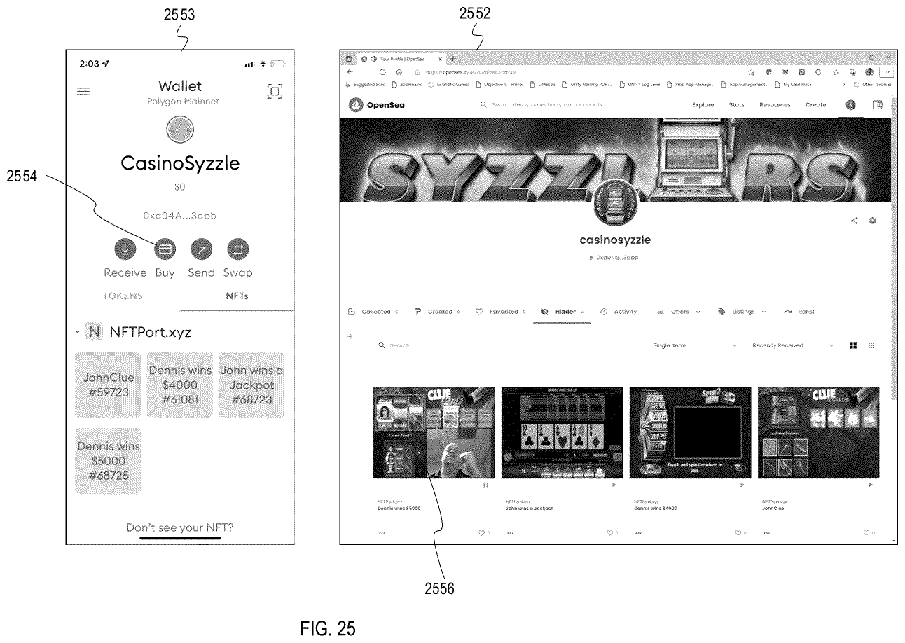

The flow 200 continues at processing block 204 where a processor generates a unique digital asset indicating game details. For instance, the moment control system 170 generates a form of digital asset, such as either the digital asset 760 (see FIG. 7B), the digital asset 802 (see FIG. 8), digital asset 906 (see FIG. 9A and FIG. 9B), NFT 2556 (see FIG. 25), or some other form of content that indicates, at least, the winning details. In some embodiments, the processor utilizes a template for generating gaming moments. The template can be one of many templates stored in a template library. Each template can vary depending on the qualifying game event, the degree or quality of the qualifying game event, or any other factor associated with the qualifying game event (e.g., the amount of the win, a type of win (e.g., progressive v. non-progressive), a type of game, etc.) The template specifies sections in which to present copies of game assets (e.g., a game video, a game image, a game symbol, etc.), sections for text details (e.g., for the winning details), sections for captured data (e.g., images of a player at the gaming device, video of a celebration at a table, etc.), and so forth. Other content can be added to the digital asset at subsequent stages, such as the captured data (e.g., images, videos, sounds, etc. captured from the gaming environment—e.g., see processing block 206). Furthermore, the digital asset may further be customized (e.g., modified, added to, cropped, enhanced, etc., —e.g., see processing block 216).

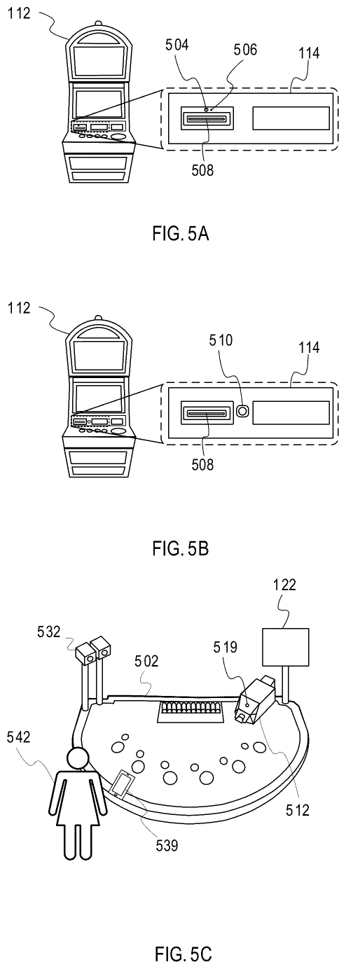

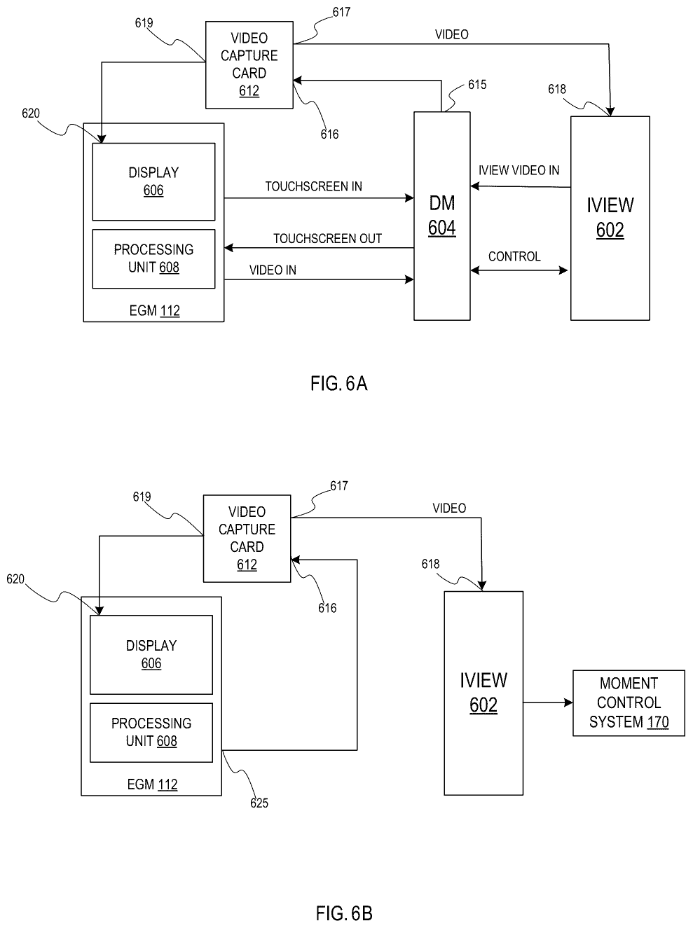

The flow 200 continues at processing block 206 where a processor determines whether there is personal captured data available. If, at processing block 206, the processor determines that personal captured data is available, then the flow 200 continues at processing block 208, where the processor incorporates the captured data into the digital asset. FIG. 4B, for instance, describes a capture manager 453 configured to capture content from the moment capture devices 152. The personal captured data includes data captured from moment capture devices that are in the physical gaming environment and directed to the player (e.g., pointed at, positioned near, etc.). FIG. 5A, 5B, and 5C illustrates some examples of moment capture devices. FIGS. 6A and 6B further describe architectures for moment capture devices in connection with the player interface system 150. Referring again to processing block 206, in one embodiment, the processor can repeat processing block 206 until some level of personal data is collected or ascertained. For example, personal data can include data collected at the gaming environment or data ascertained about the player from a casino system (e.g., the processor can turn on moment capture devices from different angles, at different locations, at various times, etc., the processor can detect player attributes by image analysis of a player images to determine a name or account identity, the processor can read player information from a player account that the player is logged into, etc.).

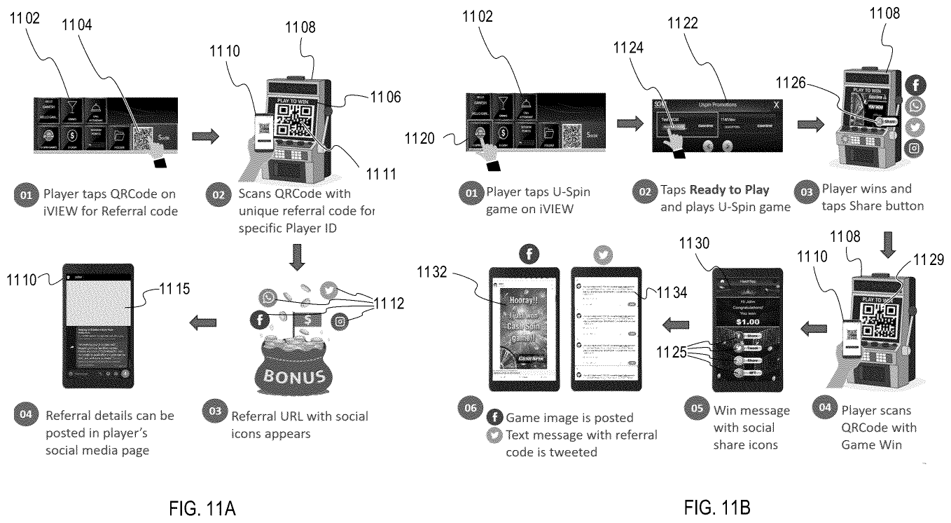

The flow 200 continues at processing block 210 where a processor generates and displays a code that is scannable by a mobile device (e.g., scannable via user computing device 50). Examples of presenting a QR code are described in FIGS. 11A and 11B (e.g., QR code 1111 or QR code 1129). After the code is scanned, the flow 200 continues at processing block 212 where a processor detects a scan of the QR code and presents the digital asset via a cross-channel application of the user computing device 50 (e.g., see FIG. 8 and FIG. 11B).

The flow 200 continues at processing block 214 where a processor determines whether there is customization input received via the cross-channel application. If, at processing block 214, the processor determines that customization input is received, then the flow 200 continues at processing block 216, where the processor customizes the digital asset based on the customization input. Examples of customization are described in connection with FIG. 7B, and FIG. 8. In some embodiments, the ability to customize the digital asset is a feature that can be toggled on or off, or that can be limited in its use according to the needs of an operator (e.g., limited in functionality, provided in tiers, etc.). For example, for specific types of gaming moments (e.g., for a win above a certain threshold, for a progressive jackpot win, etc.), the processor may exclude certain types or levels of customization options to the digital asset.

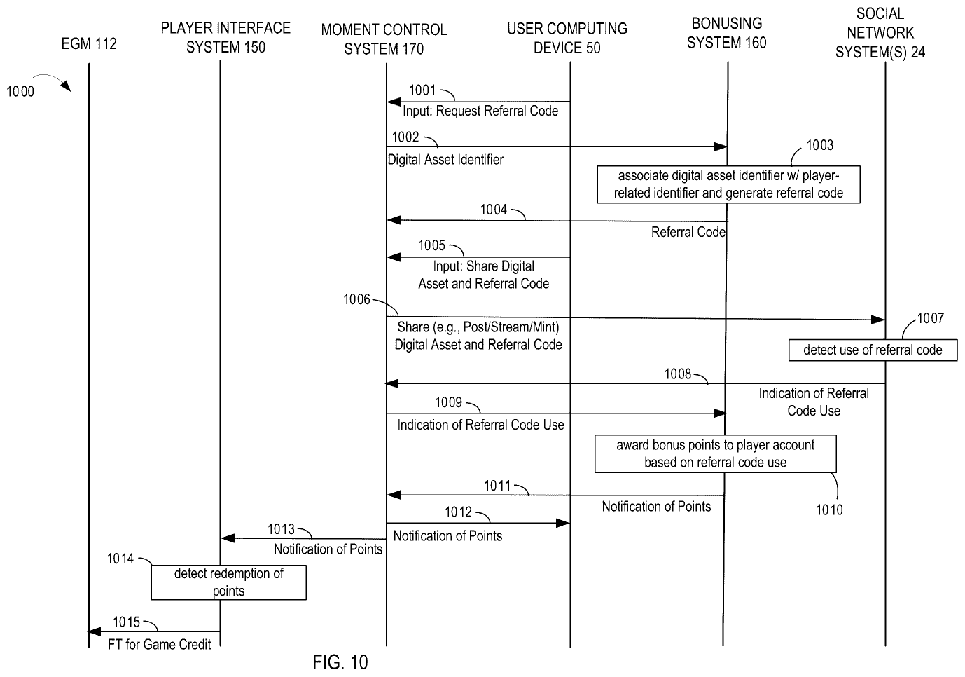

The flow 200 continues at processing block 218 where a processor determines whether there is a share input received via the cross-channel application. If, at processing block 218, the processor determines that a share input is not received, then the flow 200 returns to processing block 218 until a share input is received. If, at processing block 218, the processor determines that a share input is received, then the flow 200 continues at processing block 220, where the processor associates the digital asset with a referral code and shares the digital asset via one or more channels. In some embodiments, the processor generates a selectable link which contains metadata associated with the digital asset. The link can store the referral code as the metadata, which can be electronically read and used to refer to a patron account, profile, etc. (e.g., a player account). In some embodiments, the code (and/or link) is displayed as part of the digital asset (e.g., as a link in a text message, as a QR code on an image, etc.). Furthermore, the processor can modify or edit the various elements of the digital asset before sharing the digital asset. For instance, the processor may convert at least some moment capture data, digital asset content, captured images, etc. that is in raster graphic format into a vector graphic or line drawing format (e.g., to eliminate pixilation). FIG. 10, 11A, 11B, 12A, 12B, 13, 14, 15, 16, and 17 illustrate some examples of generating referral codes and/or sharing a digital asset (e.g., sharing to a social network or other social medial channel, generating NFTs from the digital asset and sharing the NFT via an NFT marketplace, streaming the digital asset via a livestreaming service, etc.).

The flow 200 continues at processing block 222, where a processor initiates a loop 222. In some embodiments, the loop 222 continues until loop parameters are accomplished (at processing block 228). For example, the loop 222 continues for a certain duration of time (e.g., until a bonus or award offer expires) or for a specific purpose (e.g., for a number of uses or actions). For instance, at processing block 224, the processor detects that the referral code is used via the one or more gaming channels. If at processing block 224, the processor detects that the referral code is used as well as the context of its use (e.g., uses of a certain type, duration, number, etc.), then the flow 200 continues at processing block 226 where the processor awards a certain number of bonus points to a player account based on the context of the use of the referral code. The player account is associated with the used referral code. FIG. 10, 11A, 11B, 12A, 12B, 13, 14, 16, and 17 illustrate some examples of generating awards (e.g., loyalty points) for sharing and/or using a digital asset.

FIG. 3 is a flow diagram of a flow 300 illustrating creating and customizing a digital asset in accordance with example embodiments of the present disclosure. In the example of FIG. 3, at step 301 the EGM 112 transmits, to the player interface system 150, an indication of a qualifying game event. In indication of the qualifying game event includes relevant game event details (e.g., winning details). The player interface system 150 presents, via a display of the EGM (e.g., using the iView/DM 114), the indication the qualifying game event. The player interface system 150 receives user input that initiates the creation of the digital asset. For example, the user selects an input control from the player interface system 150 (e.g., selects the input control 1126 shown in FIG. 11B). In another example, the user requests a QR code to scan (e.g., user selects user input 1104 to generate QR code 1111 in FIG. 11A). In another example, the user scans a QR code that is presented via a display (e.g., user scans QR code 714 in FIG. 7A).

At step 302, the player interface system 150 communicates the user input to the moment control system 170. Based on the user input, at step 303, the moment control system 170 requests moment data from the player interface system 150, such as images or sounds at the time of the win (e.g., images or sounds of player reactions during the game captured from moment capture device(s) 152). The player interface system 150 may further include a content controller 153 to generate an overall design for the moment (e.g., an overall look and feel), which design includes, but is not limited to: a template, a layout, graphics, icons, themes, digital copies of game assets, etc. In one embodiment, the player interface system 150 is the iView® player interface system from Light & Wonder Inc. For instance, the iView® player interface system incorporates the Web Content Management (WCM) web-based application from Light &Wonder Inc., which can be used to create and manage customized content for display via the iView® and/or via a gaming display whose position and size are controlled by the iView® Display Manager software.

At step 303, the moment control system 170 requests the moment data. The player interface system 150 receives the request for the moment data and then gathers the moment data, including any content provided by the content controller 153 as well as any moment data captured from the moment capture device(s) 152.

At step 304, the player interface system 150 communicates the moment data to the moment control system 170. At step 305, the moment control system 170 generates the digital asset using the winning details and the moment data. For example, the moment control system combines the winning details and the moment data using a template (as described in FIG. 2).

At step 306, the moment control system 170 generates a QR code that indicates information about the digital asset and transmits the QR code to the player interface system 150. In an alternative embodiment, the moment control system 170 request that the player interface system 150 generate the QR code. At step 307, the player interface system 150 presents the QR code via a display of the player interface system 150 or, alternatively, via a display of the EGM 112 (e.g., see FIG. 7A, FIG. 11A, or FIG. 11B).

At step 308, the user computing device 50 (e.g., a mobile device) reads the QR code (e.g., using a built-in camera). At step 309, based on the coded information provided in the QR code, the user computing device 50 requests the digital asset. The moment control system 170 receives the request and, at step 310 provides the digital asset to the user computing device 50 (e.g., see FIG. 7A, 9A, 25, 11A or 11B).

At step 311, the cross-channel application on the user computing device 50 presents the digital asset and customization options. The customization options relate to the customization of the digital asset (e.g., see FIG. 8). In one embodiment, at step 312, the user computing device 50 transmits the customization input related to the digital asset. At step 313, the moment control system 170 customizes the digital asset, based on the customization input. At step 314, the moment control system 170 returns the customized digital asset to the user computing device 50. In other embodiments, instead of transmitting the customization input to the moment control system 170, the cross-channel application includes functionality that customizes the digital asset and that transmits a copy of the customized digital asset to the moment control system 170.

FIG. 4A is a diagram of an architecture 400 in accordance with example embodiments of the present disclosure. The architecture 400 includes a control server 401 configured to host a control service 402. User computing device 50 communicates with the control server 401 via an application programming interface (API). The cross-channel application 410 further communicates with social network system(s) 24 using API's for the respective social network system(s) 24. A casino management system (CMS) 412 communicates with the control service 402 via an API of the CMS 412. The API can be for player and employee verification. A database 414 is associated with the CMS 412 to store data pertinent to player activity. The CMS 412 also provides communication with casino display networks (e.g., signage devices 122). In one embodiment, the CMS 412 is the ACSC™ Casino Management System product from Light & Wonder Inc.

Still referring to FIG. 4A, the architecture 400 includes a cashless gaming application 416 from which to access and redeem earned customer loyalty points. In some embodiments, the cashless gaming application 416 is installed on the user computing device 50. In some embodiments, the cashless gaming application 416 is incorporated into, or otherwise communicates with, the cross-channel application 410. The cashless gaming application 416 stores earned customer loyalty points for redemption, such as for use during game play. In one embodiment, the cashless gaming application 416 is the Unified Wallet application from Light & Wonder Inc.

The control service 402 further connects to a one-time password (OTP) service 403, a notification service 404 and an NFT service 408. In one embodiment, the NFT service 408 is integrated with the Ethereum blockchain to create NFTs and enable sales transactions of NFTs. The NFT service 408 may further include the Nethereum Library and an Infura Ethereum Client.

In some embodiments, the control service 402 is configured to generate alerts and reports related to game moments and awards, such as generating an announcement whenever a new digital asset is posted to a wall, a social network, etc., generating an alert when an NFT is posted to an NFT marketplace, an alert when awards (e.g., of bonus points) are made, etc. In some embodiments, the alerts are push alerts that send a message to a user's mobile device. Furthermore, in some embodiments the control service 402 is configured to generate reports of statistics, such a sign-up statistics, NFT user statistics, social media action statistics, sharing statistics, award statistics, etc.

FIG. 4B is a diagram of an architecture 450 in accordance with example embodiments of the present disclosure. The architecture 450 includes a bonusing system 460 with a bonusing database 465. In one embodiment, the bonusing system 460 runs the Elite Bonusing Suite TM (EBS) software from Light & Wonder Inc. The bonusing system 460 includes a bonusing platform 462 (e.g., the EBS platform), a moment API 461 (e.g., including the functionality of the moment control system 170), a social link 463 (e.g., to connect to and communicate with social network system(s) 24), and an email service 464 (e.g., to connect with a cloud computing service 470 related to email, such as the Azure cloud-computing service from Microsoft Inc.). For example, when a player makes a purchase of a digital asset (e.g., an image, a video, an NFT etc.), the email service 464 uploads a copy of the digital asset to the cloud computing service 470 using FTP and then generates a purchase-confirmation email from a template. In one embodiment the social link 463 comprises a service that exists in the Elite Bonusing Suite® (EBS) software by Light & Wonder. The service authenticates to various social media channels (e.g., social networks) and includes the capability to upload and post a video, or other such digital asset, to a social media channel. Furthermore, the EBS software provides functionality to specify types of events and/or levels of events (e.g. win threshold levels) that can be used to qualify a moment-worthy event (e.g., to specify a qualifying game event). The moment API 461 provides interfaces to upload moment data (e.g., video) to EBS software, retrieve (e.g., download, stream, etc.) the moment data, purchase the moment (e.g., purchase the digital asset), and so forth.

Still referring to FIG. 4B, in one embodiment, the iView/DM 114 includes gaming content 451 (e.g., game assets, game rules, etc.). The iView/DM 114 also includes applications and displays 452, which are used by the iView/DM 114 to present player options related to hospitality, bonusing, player accounts, digital wallets, games, moment tracking, etc. The iView/DM 114 further includes a capture manager 453 that receives captured data from moment capture device(s) 152 and, in some embodiments, controls the use of the capture devices. For example, in one embodiment the capture manager 453 is configured to start a capture, stop a capture, stream a capture, post a capture (e.g., to bonusing system 460), etc. In some embodiments, the capture manager 453 provides user controls to control or configure moment capture device(s) 152, specify content to capture, specify regions to capture within the content, or to perform other customized options, such as an option to incorporate personal video of the event captured from a user's mobile device. In one embodiment, the capture manager 453 exposes an API over web sockets, that allows for content whether in XML, Unity, HTMLS, Flash, etc. Furthermore, commands are sent via the web sockets.

The iView/DM 114 communicates with an online content tool 493, such as the Web Content Manager® (WCM) software from Light & Wonder Inc. Furthermore, the iView/DM 114 is configured to communicate with a digital wallet (DW 454), which includes an electronics payment application or a cashless gaming app (e.g., the Unified Wallet application from Light & Wonder Inc.).

FIG. 5A, 5B, and 5C are diagrams illustrating moment capture devices in accordance with example embodiments of the present disclosure. For example, in FIG. the moment capture devices (e.g., a camera 504 and a microphone 506) are incorporated into a card reader 508 of the iView/DM 114. The camera 504 and microphone 506 are positioned to face a player logged into, and seated at, the EGM 112. FIG. 5B also illustrates a device 510 having both a camera and microphone incorporated into the iView/DM 114, however the camera is a larger camera or has a larger lens (e.g., a 4K camera). Furthermore, the device 510 (with the camera and microphone) are positioned adjacent to the card reader of the iView/DM 114. FIG. 5C illustrates an example of moment capture devices at a gaming table 502. For instance moment capture devices include a camera 532 attached to the table 502. In some embodiments, other devices at the gaming table may include other moment capture devices (e.g., for a variety of angles of image capture). For example, a shuffler 512 includes a camera 519. Furthermore, moment capture devices can include a user computing device, such a smartphone 539, which is equipped with video and audio recording capabilities. In some embodiments, the smartphone 539 is used to record an image of the player 542. In some embodiments, moment capture devices may also include mobile devices of other participants at the table 502. In one embodiments, the mobile devices of all players at the table 502 can contribute content to the moment control system 170 for use with any digital asset generated for a qualifying game event, even for those related to other players.

FIGS. 6A and 6B are diagrams that illustrate moment capture architectures in accordance with example embodiments of the present disclosure. In FIG. 6A, an iView 602 and a display manager 604 are connected to EGM 112 and to a video capture card 612 (e.g., a 4K video capture card). In one embodiment, the iView 602 receives video output from the DM 604. For example, the DM 604 receives video input from the EGM 112 as well as video input of content from the iView 602. The DM 604 is configured to mix the video and provide the mixed video to the display 606 of the EGM 112. The DM 604 can further provide the mixed video to the iView 602. The iView 602 is configured to receive the mixed video and record it, such as for creation of a gaming moment. For instance, a video output 615 of the DM 604 is connected to an input 616 of the video capture card 612. In one embodiment, a display adapter is used to convert a type of video output of the DM 604 (e.g., a DVI, VGA, or DisplayPort type) to another type of video output for the video capture card 612 (e.g., HDMI). The video capture card 612 includes an output 617 which connects to an input 618 of the iView 602 (e.g., via USB 2.0 or higher). The video capture card 612 includes an additional output 619, which connects to an input 620 of a display 606 of the EGM 112. The video capture card 612 further forwards the mixed video to the display 606 for presentation via the EGM 112.

In FIG. 6B, the illustrated architecture includes the iView 602, however no display manager is included. Instead, a video output 625 from the processing unit 608 of the EGM 112 is connected directly to the video capture card 612 via input 616. The processing unit 608 provides video of game content to the video capture card 612. The video capture card 612 connects, via output 617, to the input 618 of the iView 602. The video capture card 612 provides the video output from the EGM 112 as input for the iView 602 (e.g., for use in gaming moment capture and creation). Further, an output 619 of the video capture card 612 is connected to the input 620 of the display 606. Thus, the video capture card 612 also provides the video output from the processing unit 608 to the display 606.

FIG. 7A is a diagram that illustrates creation of a gaming moment via a mobile device in accordance with example embodiments of the present disclosure. In FIG. 7A, the EGM 112 presents QR code 714 that includes coded information related to a qualifying game event, such as winning details for a win event that occurred in a wagering game. The mobile device 712 uses a camera (or other code scanner). The mobile device 712 scans the QR code 714 and presents, via a user interface 720 of the cross-channel application, a message 722 that indicates at least some of the winning details. The user interface 720 of the cross-channel application also presents one or more input controls 725 to share a digital asset of the gaming moment via one of the social network system(s) 24. The user interface 720 further presents a control 726 to convert the digital asset into an NFT. When one of the input controls 725 or 726 is selected (via user input), the cross-channel application presents a list 730 of recent qualifying game events, such as wins by the player at the EGM 112 or at other gaming devices. The list 730 presents enough detail from each of the wins to identify a specific win event. For example, the list 730 presents, for each entry, one or more of a game identifier, a game name, a total bet placed, a total amount won, a date, a time, etc. The player selects one of the entries (e.g., entry 731) whose winning details (and other moment data), will be used to create the digital asset.

FIG. 7B is a diagram that illustrates creation of a gaming moment via a user computing device in accordance with example embodiments of the present disclosure. In FIG. 7B, a user computing device presents, via a browser 750, a webpage 752 connected to a control service (e.g., similar to control service 402 of FIG. 4A). The webpage 752 includes a moment control feature 754 by which a player, or a casino employee, can generate, access, or otherwise modify, a digital asset 760 and specify details pertaining to the digital asset 760 (e.g., a title, a type, a description, name(s) of player(s), etc.). The moment control system 170 further presents an icon 756 of the digital asset 760. The icon 756 is selectable via user input. When the icon 756 is selected, the moment control feature 754 presents the full version of the digital asset 760 (e.g., a video, a higher resolution image, etc.). Furthermore, the moment control feature 754 includes an input control 758 to post the digital asset 760 (e.g., to a social network, to a marketplace, to a virtual “wall” of winners, etc.).

FIG. 8 is a diagram that illustrates customization of a digital asset in accordance with example embodiments of the present disclosure. As shown in FIG. 8, a mobile device presents a customization tool 801. The customization tool 801 presents a digital asset 802. In one embodiment, the customization tool 801 provides a library 804 of images that are of the player, or that are related to player. The library may include, for example, images of the player stored on the mobile device, images captured of the player by moment capture devices during a qualifying game event, images of the player from a player account or other social network account, etc. In another embodiment, the library may include avatars of the player (e.g., vector graphic versions of images of the player). For instance, images of the player can be scanned while the qualifying game event occurs (e.g., while the player is at a gaming machine or gaming table). The different images can be from different angles (if there are multiple cameras) or at different times (e.g., according to a specific shutter speed of a camera). The multiple images can be scanned (e.g., by the moment control system 170) and converted into a plurality of avatars (in vector graphic form) using the likeness of player, and having different poses, facial expressions, etc. as depicted in the image. The avatars can also be skinned or textured with clothing that is either similar or different to that of the apparel worn by the player in the images or that is different. The avatars can also be auto-generated to have apparel, or other features (e.g., props, backgrounds, additional characters, game assets, etc.) that are based on a game theme, a special event at the time (e.g., a season, a holiday, a birthday, a convention, a celebration, etc.), and so forth. In some embodiments, the customization tool 801 includes a feature to select different attributes of the avatar, such as a pose, clothing, eyes, eyewear, head-size, head gear, mouth, abilities, traits, tiers or status, and so forth. The library 804 presents the plurality of avatars for selection by the player and/or for positioning on different sections or locations of the digital asset. In some embodiments, the digital assets can be customized and grouped into collections (e.g., collections of NFTs) which can be pit against each other (e.g., to do battle in a game) or which can combine with other groups of digital assets (e.g., to cooperate in a group game). In one example, digital assets from a wagering game can be selected (e.g., by random or by qualification, such as above a certain winning threshold) and included in the group of digital assets to affect its rarity and/or to give it abilities that can be used in later games. A player can also pay extra to have a unique item or attribute (e.g., a Queen of Hearts card or symbol, a Bally™ logo, a specific game character or character attribute (e.g., Mr. Monopoly, Zeus, one of the 88 babies, Mr. Monopoly's hat, Zeus' thunderbolt, etc.), etc.). Based on the selected (or purchased) items or attributes, different items appear in the library 804 which can be selected for inclusion on the digital asset. The attributes can include abilities or traits that can translate to smart-contract items (e.g., on-chain code) or off-chain attributes (e.g., off-chain code for hybrid smart contracts).

In addition, the customization tool 801 presents a selection control 806 (e.g., a bar menu, a dropdown, etc.) that lists a plurality of choices to change a thematic element of the digital asset (e.g., a background color, a layout style, etc.). Furthermore, other elements of the digital asset that may be customized include, but are not limited to, one or more of the following: the game name, a game identifier, a bet amount, a win amount, a referral code, a casino name, etc. For instance, an input control 808 is provided that, in response to user selection, causes the moment control system 170 to generate a referral code that is specifically related to the digital asset and/or to the player. For example, the referral code may be generated as a new code and assigned, via a collection of related data (e.g., via a spreadsheet, a database, etc.) to an identifier for the digital asset and/or an identifier for the player (e.g., a mobile phone number, a player account identifier, etc.). When generating an NFT as the digital asset, the referral code may also be related to an NFT identifier (e.g., to a token identifier) which is related to the NFT and which is used to track the action of the NFT (e.g., use, sale, transfer, loan, etc.). In some embodiments, the referral code is included into the details of a smart contract associated with the NFT. In some embodiments, the referral code is a URL or a web link. In other embodiments, the referral code includes a QR code which can be scanned (e.g., by another individual) via a personal mobile device, a scanner, etc.

The customization tool 801 further includes a feature (e.g., input control 810) to select a file to customize. For instance, any digital asset that is customized can be stored (e.g., in the memory of the mobile device, in the moment control system 170, etc.) and which can be accessed for further customization. Multiple images can be customized and included into a collection of digital assets (e.g., for upload to an NFT marketplace as an NFT collection). The multiple images can be of the same event or of multiple events. In some embodiments, the customization tool 801 provides levels or tiers of customization options. Some customization options may be unlocked based on subscription levels, purchase history (e.g., past purchase of digital assets or NFTs), possession of specific digital assets (e.g., an NFT having customization benefits), a number of bonus points, a casino loyalty-account status, a degree or attribute of the qualifying game event (e.g., if the win is above a threshold amount), and so forth. For example, customizations options can be separated into a basic level and a premium level. For the basic level, the customization tool 801 provides options to make basic level changes such as to add new images, customize images (or other aspects of the digital asset) such as with a change of colors, an addition of an avatar, an addition of a casino logo, etc. For the premium level, the customization tool 801 provides options of the basic level as well as options to change themes based on seasonal celebrations, customize images with different accessories, etc. The different levels or tiers of customization can be earned, as well as purchased, such as being based on a number or level of bonus points achieved, a seniority of the customer, etc.

The customization tool 801 further includes a feature (e.g., input control 812) to download/upload the customized digital asset to a gaming channel (e.g., a casino wall, a gaming), to a social network system, to an NFT marketplace (e.g., the OpenSea NFT marketplace), etc.

FIG. 9A, 9B, 9C, and 25 are diagrams that illustrate purchasing digital assets in accordance with example embodiments of the present disclosure. In FIG. 9A, a display 902 of a gaming machine (e.g., of EGM 112) presents a mixed-video combination of game content and system content. The system content includes a list 904 of a plurality of digital assets for purchase from the casino (e.g., digital assets created and offered for sale by the casino via the player interface system 150). The digital assets are for moments captured in response to qualifying game events. Each of the digital assets includes a price of purchase and at least one user-interface control object (e.g., a button) which, in response to user input, purchases the associated digital asset. For example, the digital asset 906 is listed for sale at twenty-five dollars ($25.00). An input control 908 is associated with the digital asset 906. The input control 908 can be selected to purchase digital asset 906.

In FIG. 9B, after the input control 908 is selected, a confirmation screen 920 appears. When input control 921 is selected, a digital wallet screen 922 appears indicating available player funds. If player funds are sufficient, the purchase can be made (e.g., via input control 923). A purchase confirmation screen 924 then appears indicating instructions to download the digital asset (e.g., via a link sent to a mobile device or via email sent to an email address associated with a player profile).

In FIG. 9C, a user can purchase an NFT directly from a casino wall, or other NFT marketplace. For example, in one embodiment, the bonusing system 460 utilizes the NFTPort infrastructure. Via the NFTPort infrastructure, the specific blockchain used for minting can be specified (e.g., the Polygon blockchain, the Ethereum blockchain, etc.). Further, via the NFTPort infrastructure the wallet address (to where the NFT should be transferred to) is specified. For example, the wallet address is associated with a MetaMask crypto-wallet account (e.g., see also FIG. 25, where a MetaMask wallet account is shown for a given subscriber or operator (e.g., “Casino Syzzle”)). Furthermore, NFTPort infrastructure can automatically upload digital assets, such as NFTs, to the OpenSea marketplace, after which the subscriber can place digital assets (e.g., NFTs) for sale.

As shown in FIG. 25, the purchase of an NFT 2556 includes a user (e.g., a player, a casino employee, etc.) connecting, (e.g., via a web browser 2552, via an app, etc.), to an NFT marketplace, such as the OpenSea marketplace. For instance, the NFT 2556 (along with other NFTs) are listed for sale via the OpenSea marketplace. In response to a user selection of the NFT 2556 (e.g., via selection of the thumb-nail image of the NFT 2556, via selection of an input control to purchase the NFT 2556, etc.), crypto wallet application 2553 launches (e.g., the MetaMask crypto wallet application), from which the user can confirm the purchase (e.g., via selection of input control 2554). In one embodiment, the details for the specific NFT for purchase, as well as the details of the crypto wallet of the seller, can be automatically populated into the purchase details of the crypto wallet application 2553 when the digital asset (e.g., the NFT 2556) is selected for purchase. The funds for the purchase move from the crypto wallet of the purchaser to a crypto wallet of the seller. The NFT is then transferred from the crypto wallet of the seller to the crypto wallet of the purchaser.

FIG. 10 is a flow diagram of a flow 1000 illustrating associating a referral code with a digital asset and tracking usage of the referral code in accordance with example embodiments of the present disclosure. In the example of FIG. 10, at step 1001 the user computing device 50 (e.g., a mobile device) receives (e.g., via a user interface of a cross-channel application) user input that requests a referral code (e.g., in response to selection of input control 808 in FIG. 8). The user computing device 50 transmits the request to the moment control system 170. The moment control system 170 receives the request and, in response, at step 1002, transfers to the bonusing system 160 a digital asset identifier. The bonusing system 160 receives the digital asset identifier, and at step 1003 associates the digital asset identifier with a player-related identifier (e.g., associates the digital asset identifier with a player account identifier via a data relationship stored in database 190). Further, at step 1003, the bonusing system 160 generates a referral code. The referral code includes referral information related to one or more of the digital asset identifier and/or the player-related identifier.

At step 1004, the bonusing system 160 transmits the referral code to the moment control system 170. In some embodiments, the moment control system 170 associates the referral code with the digital asset. For instance, the moment control system 170 can incorporate the referral code into a QR code that is presented on the digital asset. In another example, the moment control system 170 can include a URL of the code on the digital asset. In other embodiments, the moment control system 170 includes the referral code as metadata of the digital asset, which metadata can be read electronically. The moment control system 170 can further notify the user computing device 50 that the referral code was created and associated with the digital asset (e.g., via selection of one of the input controls 725 or 726 in the cross-channel application).

At step 1005, the user computing device 50 receives user input (e.g., in response to selection of one or more of the input controls 725 or 726 in the cross-channel application) to share the digital asset with the social network system(s) 24. In some embodiments, the social network system(s) 24 can post the referral details in a player's social media page. In some embodiments, the social network system(s) 24 can post a text message (e.g., a Tweet) that includes the referral code. At step 1007, the social network system(s) 24 detects a use of the referral code. For example, the use of the referral code may include performing an action via a social network platform that uses the digital asset in a referral context, such as subscribing to a user account via a website on which the digital asset is presented, watching a live stream of the digital asset, transferring ownership of the digital asset, detecting a competition or game in which the digital asset is used, detecting an action of an NFT, etc. At step 1008 the social network system(s) 24 transmit to the moment control system 170 one or more indications of the referral code use. For instance, the social network system(s) 24 transmit to the moment control system 170 one or more messages indicating the referral code and details of the use (e.g., a type of use, a duration of use, a number of uses, etc.). The moment control system 170 receives the message(s) and, at step 1009, transmits to the bonusing system 160 the indication(s) of the referral code use (e.g., transmits the message(s) indicating the referral code and the details of use).

At step 1010, the bonusing system 160 awards bonus points to the player account based on the referral code use. Depending on the details of the use, the bonusing system 160 awards different amounts or levels of points. At step 1011, the bonusing system 160 transmits a notification of the awarded points to the moment control system 170. At step 1012 the moment control system 170 transmits the notification of the points to the user computing device 50 (e.g., for presentation via the cross-channel application). At step 1013 the moment control system 170 transmits the notification of the points to the player interface system 150. For instance, a player may be logged into the player interface system 150 using the player account.

At step 1014, the player interface system 150 detects a redemption of the points (e.g., via selection of an input control of the player interface system 150). For instance, the iView/DM 114 presents content that indicates the points were awarded to the player account. In some embodiments, the points may be limited or restricted in their redemption for use only for play purposes, not for cash-equivalent cash-out. In another example, the points may be used for only a suite or selection of games available via the player interface system 150. For example, the points may be available for use only with games that use U-Spin® technology available via the iView® product. In another embodiment, the points may be used to purchase an NFT from the casino.

At step 1015 the player interface system 150 performs a protocol for electronic transfer of funds (referred to herein as “funds transfer”) to add at least a portion of the points to a credit meter (e.g., of the EGM 112, of the gaming machine 2310, etc.) or for use of a promotional token or credit at a gaming table. The protocol for the funds transfer includes, but is not limited to, the Advanced Funds Transfer (AFT) protocol or the Electronic Funds Transfer (EFT) protocol. AFT is a secure technology for transferring funds between a gaming machine and a casino accounting system. AFT can be used to transfer funds associated with player tracking accounts.

As mentioned at step 1001, the user computing device can request a referral code from the moment control system 170. In other examples, other devices, such as the player interface system 150 can request the referral code (e.g., see FIGS. 11A and 11B).

FIGS. 11A and 11B are diagrams that illustrate generation and sharing of referral codes in accordance with example embodiments of the present disclosure. In FIG. 11A, at a first stage (stage “1”) a player accesses a user interface 1102 of a player interface system (e.g., an iView® user interface or touch-screen display) and provides a user input via an input control 1104. In response to the user input, the iView generates a QR code 1111. The QR code 1111 is unique to a specific identifier (e.g., a player profile identifier, an account identifier for a player account logged into the player interface system 150, etc.). At a second stage (stage “2”), the player interface system presents the QR code 1111 via a display 1106 of a gaming machine 1108 (to which the player interface system is connected). A personal computing device of the player (e.g., mobile device 1110) scans the QR code 1111. At a third stage (stage “3”) the mobile device 1110 generates a referral URL. Social network icons 1112 appear (e.g., in a cross-channel application on the mobile device 1110). When one of the social network icons is selected, the referral URL is provided to the related social network in a format required by the social network (e.g., in a text message, as a post, included as part of a game stream, etc.). The cross-channel application can access player login information from the mobile device 1110 and/or from a profile of the user account logged into the player interface system 150. At a fourth stage (stage “4”) the URL (along with any associated digital asset or link to the digital asset) is posted to a player's social media page 1115.

In FIG. 11B, at a first stage (stage “1”) a player accesses the user interface 1102 and provides a user input via an input control 1120 to select a game that uses the U-Spin® technology. At a second stage (stage “2”), the player interface system presents a screen 1122 that includes an input control 1124, which, when selected, launches the game. At a third state (stage “3”), in response to a qualifying event in the game the gaming machine 1108 presents an input control 1126 to share information about the qualifying event and the referral code. At a fourth stage, (stage “4”), the gaming machine 1108 presents a QR code 1129. The mobile device 1110 scans the QR code 1129 (e.g., similar to FIG. 7A). At a fifth stage (stage “5”), the mobile device 1110 presents, via a cross-channel application 1130 of the mobile device 1110, input controls 1125 configured to respond to user input (e.g., also similar to FIG. 7A). At a sixth stage (stage “6”), one of the input controls 1125 is selected. The cross-channel application initiates transfer of the referral code (along with a digital asset 1132, text message 1134, or other indication of the win), to an associated social network, NFT marketplace, etc. in a format required by the social network, NFT marketplace, etc. (e.g., in a text message, as a post, included as part of a game stream, as a minted NFT, etc.).

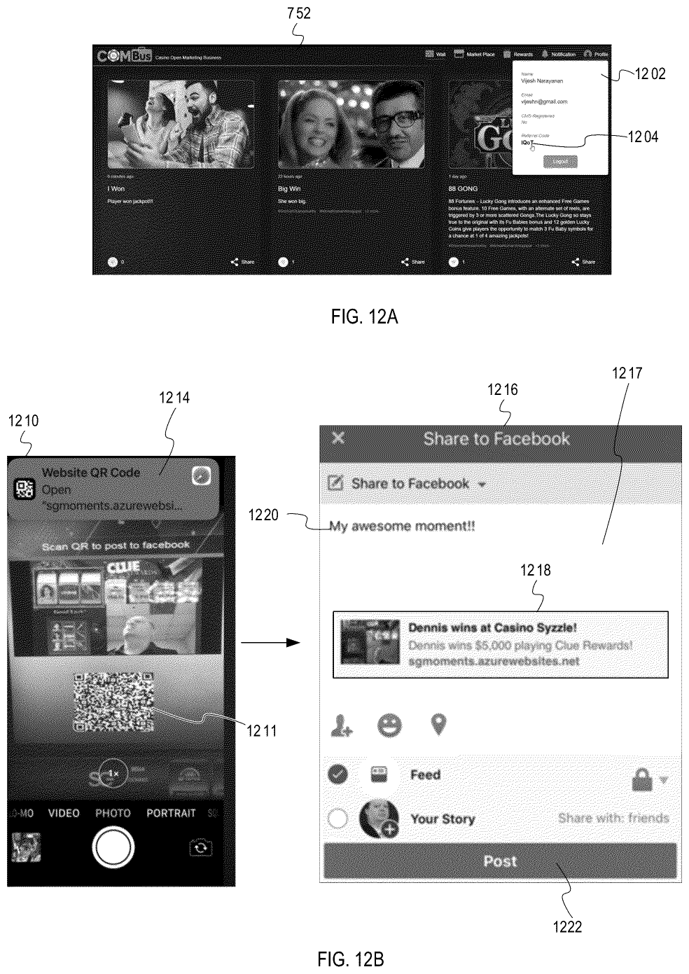

FIGS. 12A and 12B are diagrams that illustrate generating and sharing of moments with associated referral codes in accordance with example embodiments of the present disclosure. In FIG. 12A a user computing device presents the webpage 752 (see FIG. 7). The webpage 752 includes a profile 1202 for a user (e.g., a player). The webpage 752 (e.g., via the control service 402) generates a unique referral code 1204. The referral code 1204 can be selected and used for any sharing of gaming moments.

In FIG. 12B, a camera application 1210 of a mobile device is used to capture an image of a QR code 1211 presented on a display of a wagering game machine (e.g., see FIG. 11A). The QR code 1211 includes details of a captured winning moment as well as a referral code. When the QR code 1211 is selected (e.g., via user input in the camera application 1210), a web link is generated 1214. In one example, the web link 1214 is for a website at which the user can decide to share the moment. Furthermore, the web link 1214 can be activated to launch (e.g., via the mobile device) a social media application 1216 and insert a selectable object 1218 into a body of a draft social-media message (“message 1217”). Additional comments 1220 can be added by the user inside the body of the message 1217. Furthermore, the social media application 1216 includes an input control 1222 which can be selected to post the message 1217. The selectable object 1218 includes metadata (obtained from the QR code 1211), which (when the selectable object 1218 is selected) causes the social media channel to present a version of the digital asset (e.g., a video) that shows the gaming moment. Furthermore, the selectable object 1218 includes metadata (obtained from the QR code 1211) for a referral code associated with the player (e.g., a player account) and/or the casino operator. When the selectable object 1218 is selected (via the social media channel), the referral code can be used to confer or attribute a benefit to the posting user and/or the casino operator (e.g., a benefit can be attributed to the social media account, to a casino bonusing account, etc.). Furthermore, in some embodiments, an option is made available for automated posting of moments to the social network on behalf of the player. For example, input controls can be presented by which the user can select to either allow or not allow the automated posting.

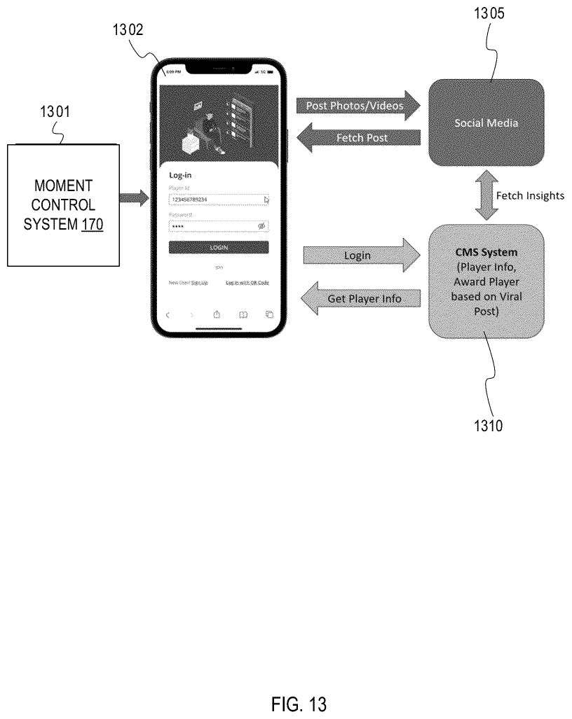

FIG. 13 is a diagram illustrating posting moments and awarding a patron in accordance with example embodiments of the present disclosure. In one embodiment a casino can run a promotion for awarding viral posts of moments captured on a casino floor in response to a qualifying game event. For instance, the moment control system 170 provides the content for the post (e.g., a digital asset) to a cross-channel application 1302. The cross-channel application 1302 makes the post to a social media channel 1305 (e.g., a social network, a live stream game server, etc.). The social media channel 1305 provides information (e.g., post statistics) to a casino management system 1310 (“CMS 1310”) associated with the casino. In one example, the CMS 1310 fetches the information (e.g., the post statistics) from the social media channel 1305. Based on post statistics (e.g., based on a number of views, likes, etc., of the post), the CMS 1310 can award a number of bonus points. The CMS 1310 can get player information from the cross-channel application 1302.

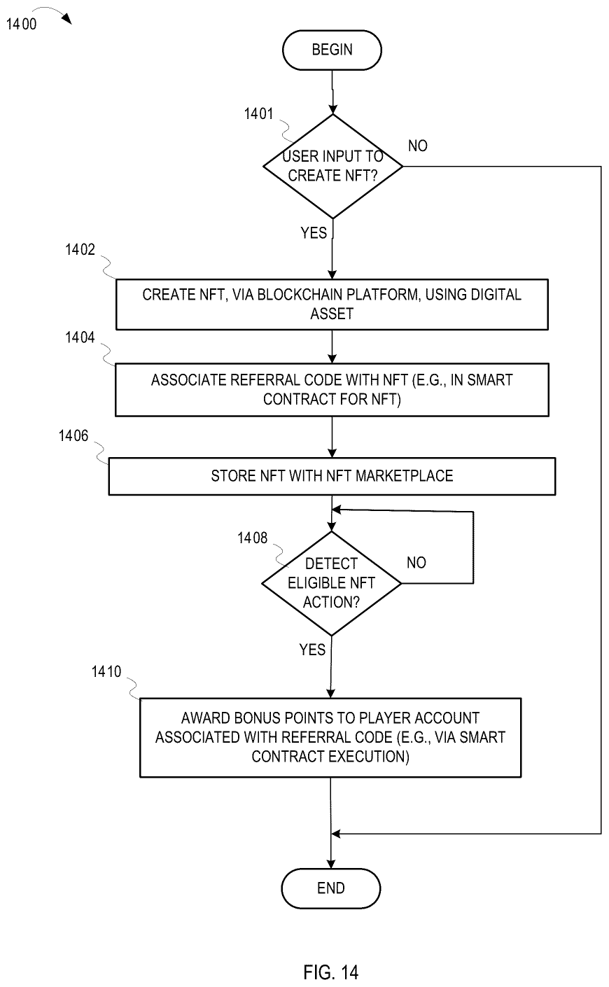

FIG. 14 is a flow diagram of a flow 1400 illustrating moment control operations and awards for an NFT in accordance with example embodiments of the present disclosure. The flow 1400 will refer to a processor. It should be noted that the reference to the processor may refer to the same physical processor or it may be one of a set of a plurality of processors. The set of processors may operate in conjunction with each other and may be distributed across various networked devices. The types of processors may include a central processing unit, a graphics processing unit, any combination of processors, etc. In one embodiment, the processor may refer to the central processing unit (CPU) 2342 (FIG. 23) or a processor in another device mentioned herein, such as a processor associated with a table controller, a card-handling device, a camera controller, a game controller, a gaming server etc.

Referring to FIG. 14, the flow 1400 begins at processing block 1401 where a processor determines whether there is user input received to indicate a creation of an NFT via the cross-channel application. If, at processing block 1401, the processor determines that user input is received, then the flow 1400 continues at processing block 1402, where the processor creates an NFT, via a blockchain platform, using the digital asset for the shareable game moment. In one embodiment, the processor (e.g., from the moment control system 170, or the moments API 461) uses the NFTPort infrastrucure and APIs (from Taivo Pungas) in combination with the Metamask software cryptocurrency wallet (from ConsenSys Software Inc.), the Polygon secondary scaling solution by Polygon Technology, the Ethereum blockchain platform. Furthermore, the previously-mentioned U.S. Patent Application No. 63/306,226 describes one or more examples of generating an NFT via the digital platform, the NFT portal system 32, and/or the intermediary server system 30.

The flow 1400 continues at processing block 1404 where a processor associates a referral code with the NFT. For example, the processor includes the referral code in a smart contract associated with the NFT. In some embodiments, the referral code is a unique code that is associated with a particular user or user account (e.g., a casino account, a player account, etc.). In some embodiments, the referral code includes information that identifies a source to which a referral input can be linked (e.g., the referral input can be from a user of the digital asset, from a purchaser of the digital asset, from a viewer of the digital asset, from a subscriber associated with the digital asset, etc.). In some embodiments, the moment control system 170 stores in the database 190 the referral code as well as any information pertinent to the referral code, such as a token identifier and an associated user account (e.g., for a player). In some embodiments, at the NFT smart-contract code is non-alterable after the NFT is minted. Hence, in some instances, the smart-contract is a hybrid smart contract whereby on-chain code includes information (e.g., name, address, etc.) that refers to an entity or device (e.g., the casino that originally generated the digital asset/NFT, the provider of the bonusing system 160, etc.), and off-chain code (e.g., stored in the database 190) refers to a specific player (e.g., referral codes that refer to a player profile or account). If the NFT is transferred, then the off-chain code can be modified to update a new player profile or account to which awards (e.g., points) will accrue. Royalties from sales of digital assets (e.g., NFTs) can be provided to the entity or device whose information is indicated in the smart contract. The royalties can be based on a percentage of a sales price each time the digital asset is sold. The percentage value of the royalty can also be included in the code of the smart contract.

The flow 1400 continues at processing block 1406 where a processor stores the NFT with an NFT marketplace. In some embodiments, the processor presents, via a cross-channel application, and list of possible NFT marketplaces from which to select.

The flow 1400 continues at processing block 1408 where a processor detects whether an eligible NFT action occurs. The previously-mentioned U.S. Patent Application No. 63/306,226 describes examples of NFT actions including, but not limited to: making an NFT, trading an NFT, awarding an NFT, creating equity in an NFT, buying an NFT, depleting/recharging an NFT, winning an NFT, lending/leasing an NFT, publishing a time to availability map of an NFT (e.g., Roadmap NFT), loaning an NFT, providing a bond NFT, providing an identity (e.g., of a player) via an NFT, insuring an NFT, or other action relating to the generation, modification, transfer of an NFT.

If, at processing block 1408, the processor determines that an eligible NFT action is not received, then the flow 1400 returns to processing block 1408 until an eligible NFT action is detected. If, at processing block 1408, the processor detects that the eligible NFT action occurred, then the flow 1400 continues at processing block 1410, where the processor awards bonus points to a player account associated with the referral code. For example, the smart-contract executes the smart-contract code therein related to the referral code. The smart-contract code can instruct the bonusing system 160 to award the points based on the particular NFT action. Different amounts of points can be awarded based on the different NFT actions.

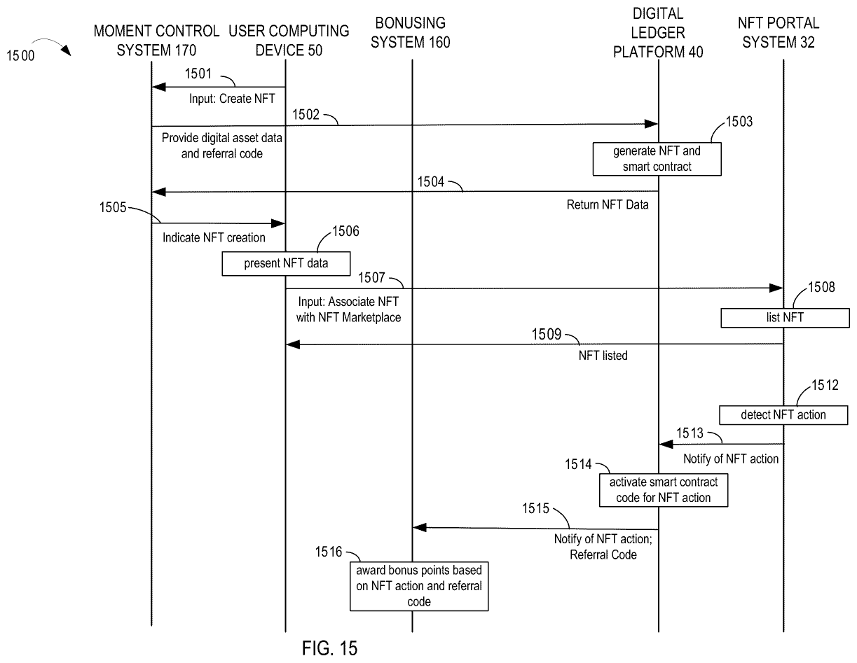

FIG. 15 is a flow diagram of a flow 1500 illustrating creating a game moment NFT and awarding NFT actions in accordance with example embodiments of the present disclosure. In FIG. 15, at step 1501 a user computing device 50 transmits, to the moment control system 170, an indication of user input to create an NFT using a digital asset of a particular gaming moment. At step 1502, the moment control system 170, provides digital asset data (e.g., the digital asset, a digital asset identifier, referral code, eligible NFT actions, identity of ownership, casino name, etc.) to the digital ledger platform 40. Any fees required for block-chain computing (e.g., gas fees) are extracted from a crypto wallet associated with the user computing device 50. At step 1503, the digital ledger platform 40 generates the NFT and a smart contract for the NFT. The smart contract includes at least a portion of the digital asset data, including the referral code. At step 1504, the digital ledger platform 40 returns NFT data to the moment control system 170, including a token identifier. At step 1505, the moment control system 170 transmits, to the user computing device 50 (via the cross-channel application), at least a portion of the NFT data required for identification and access. At step 1506, the user computing device presents the NFT data via the cross-channel application.

At step 1507, the user computing device 50 receives an additional user input to associate the NFT with an NFT marketplace. The user computing device 50 sends a notification to an NFT portal system 32 associated with the NFT marketplace. The notification can also include details pertinent to listing of the NFT (e.g., NFT name, NFT details, NFT price, etc.) At step 1508, the NFT portal system 32 lists the NFT on the NFT marketplace. At step 1509, the NFT portal system 32 sends a message to the user computing device 50. The message indicates the details of the NFT listing.

At step 1512, the NFT portal system 32 detects an eligible NFT action (e.g., a sale, a lease, a use, etc.). At step 1513, the NFT portal system 32 sends a notification of the NFT action to the digital ledger platform 40. At step 1514, the digital ledger platform 40 activates the smart contract code related to the NFT action. The smart contract code includes the referral code. At step 1515, the digital ledger platform 40 notifies, in response to activating the smart contract code, the bonusing system 160 of the executed smart contract code. The notification from the digital ledger platform 40 includes the referral code. At step 1516, the bonusing system 160 awards bonus points based on the NFT action and the referral code. For example, the bonusing system 160 looks up the referral code in the database 190 and determines that it is associated with a specific player account. Furthermore, the bonusing system 160 detects the NFT action and/or other information pertinent to bonusing (e.g., a player status, a subscription tier, etc.), and based on the information awards a specific amount of points that relate to the NFT action and/or the other information.

In some embodiments, a casino employee can generate and list NFTs via the NFT marketplace. A patron can purchase the NFTs from the marketplace. The patron can receive bonus points for the purchase. Furthermore, the patron can sell or auction the NFT to a casino. The casino can verify that the NFT is valid. Once verified, and the sale transaction is completed, the casino can award bonus points to the player account.

In some examples, bonus points can be limited in their use. For instance, the bonus points can be limited only to game play (e.g., no cash-out option). In another example, the points can be limited to only a portion of a wager (e.g., a maximum of 30% of a wager is from the bonus points and remainder is funded by credit meter balance). In some embodiments, the type or value of the wager limits the use of the points. For example, player must wager at threshold amount to be able use the points. For example, for a game worth $200, a player would need to wager $150 of their own funds to redeem the points for the remaining $50 of the required $200 bet.

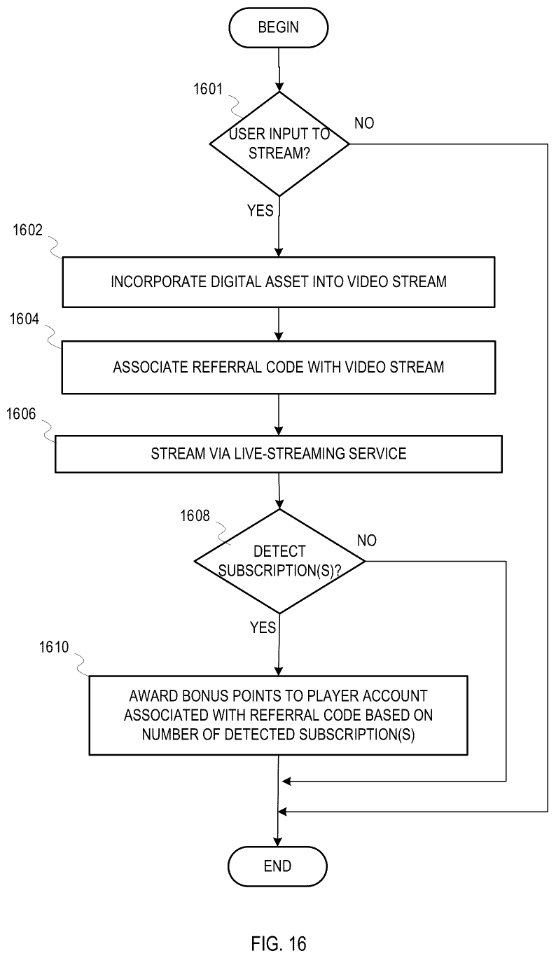

FIG. 16 is a flow diagram of a flow 1600 illustrating moment streaming and awarding in accordance with example embodiments of the present disclosure. Flow 1600 will refer to a processor. It should be noted that the reference to the processor may refer to the same physical processor or it may be one of a set of a plurality of processors. The set of processors may operate in conjunction with each other and may be distributed across various networked devices. The types of processors may include a central processing unit, a graphics processing unit, any combination of processors, etc. In one embodiment, the processor may refer to the central processing unit (CPU) 2342 (FIG. 23) or a processor in another device mentioned herein.

Referring to FIG. 16, the flow 1600 begins at processing block 1601 where a processor determines whether there is user input received to stream a digital asset. If, at processing block 1601, the processor determines that user input is received, then the flow 1600 continues at processing block 1602, where the processor incorporates the digital asset into a video stream.

The flow 1600 continues at processing block 1604 where a processor associates a referral code with the video stream. For example, the processor associates the referral code with the stream using an API for the live-streaming service, such as the Twitch® livestreaming service. In some embodiments, the processor access login credentials for the livestreaming service from a profile of a user account (e.g., a player account, a casino account, etc.). The processor associates the referral code with the user account.

The flow 1600 continues at processing block 1606 where a processor streams the video stream via the livestreaming service. In one embodiment, such as prior to initiating the live video stream, the processor detects ambient lighting levels to determine whether the image of the video stream is of sufficient quality for viewing. If the lighting is too low, the processor can modify the video stream attributes (e.g., increase the brightness and/or contrast of the video images prior to streaming them) and/or add light to the gaming environment (e.g., transmit a signal to turn up a light intensity of a nearby digital-signage display, instruct the casino lighting system to increase overhead lighting in the casino at the game-play location, send an instruction to the mobile device application to turn on a flash or flashlight, turn on a small focus light adjacent to a camera lens (e.g. a camera lens at the gaming machine), etc.). During the livestreaming, audience members can subscribe to the livestreaming service. The livestreaming service tracks the number of new subscriptions from the livestreaming event.

The flow 1600 continues at processing block 1608 where a processor detects whether subscriptions occurred during the livestreaming. The processor also tracks the number of subscriptions. If, at processing block 1608, the processor detects the number of subscriptions, then the flow 1600 continues at processing block 1610, where the processor awards bonus points to a player account associated with the referral code based on the number of detected subscriptions.

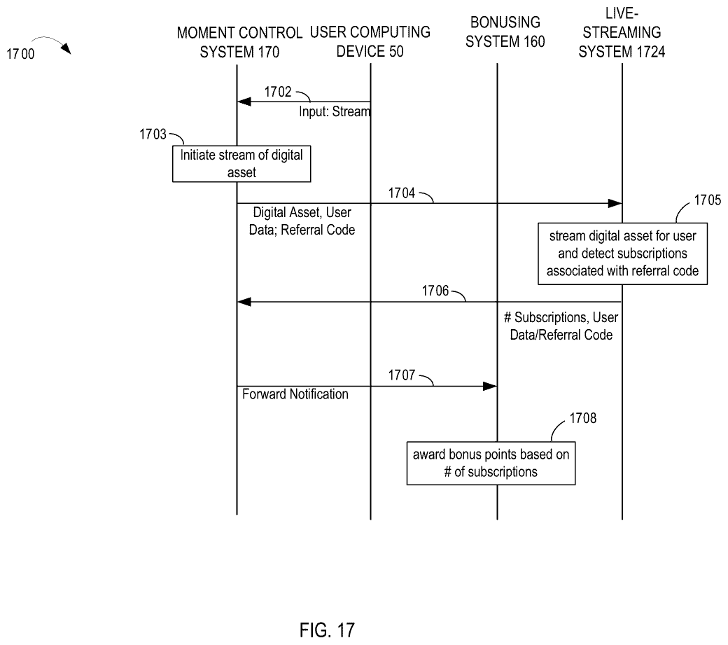

FIG. 17 is a flow diagram of a flow 1700 illustrating livestreaming a game moment and awarding points in accordance with example embodiments of the present disclosure. In FIG. 17, at step 1702 the user computing device receives user input to initiate a live stream of a digital asset for a game event (e.g., live stream of a game, a game session, a tournament, etc.). In some embodiments, the user computing device 50 is associated with a casino patron, such via an identifier of a profile, user account, etc. At step 1703, the moment control system 170 initiates the streaming of the digital asset. For example, referring to FIG. 4B, the capture manager 453 can convert content associated with the digital asset (e.g., convert at least a portion of the gaming content 451, convert data received from the moment capture device(s) 152, and/or convert content provided from the online content tool 493), to a live streaming file format, such as the Motions Picture Experts Group (MPEG) format, or the FF Video 1 (FFV1) format (e.g., using the open-source ffMPEG tool available at ffmpeg.org).

At step 1704, the moment control system 170 transmits, to a livestreaming system 1724, a notification to initiate the live stream via the livestreaming service. The notification includes information required by the livestreaming service to post the stream. The required information includes the digital asset (or a link to the digital asset) and user data associated with a livestreaming account (e.g., login credentials). The notification further includes the referral code.

At step 1705, the livestreaming system 1724 authenticates the user data and posts the live stream of the digital asset via the livestreaming service. During broadcast of the live stream, the livestreaming system 1724 tracks any subscriptions to the livestreaming event and/or to a related account from audience members of the livestream (e.g., from other users of the livestreaming service). At step 1706, the livestreaming system 1724 transmits a message to the moment control system 170 describing the number of subscriptions as well as any data required by the moment control system 170 to award bonus points to the appropriate patron. For example, the message includes the referral code, which the moment control system 170 uses to determine the specific player account. At step 1707, after determining the player account (e.g., a player account associated with the referral code), the moment control system 170 notifies the bonusing system 160. At step 1708, the bonusing system 160 awards, to the player account, bonus points based on the number of subscriptions.

In one embodiment, the iView/DM 114 is configured to perform the functions mentioned in FIG. 17 related to the moment control system 170. For example, the iView/DM 114 is configured to communicate directly with the livestreaming system 1724, instead of the moment control system 170, to start and stop the stream and to forward notifications to the bonusing system 160 regarding the subscription data and/or referral codes.

In some embodiments, the bonusing system 160 can monetize streams by including metered billing in the Unified Wallet application. In some embodiments, the moment control system 170 can post to a media eco-system on the floor, similar to a winners wall (e.g., post to a digital signage network, such as the CoolSign® product from Light & Wonder Inc.). In some embodiments, the bonusing system 160 awards a user bonus points as the user gets more subscriptions to their Twitch streams (gives points based on how many other subscribers can be referred to the games, award points for subscribers initial and/or ongoing use of the games, etc.).

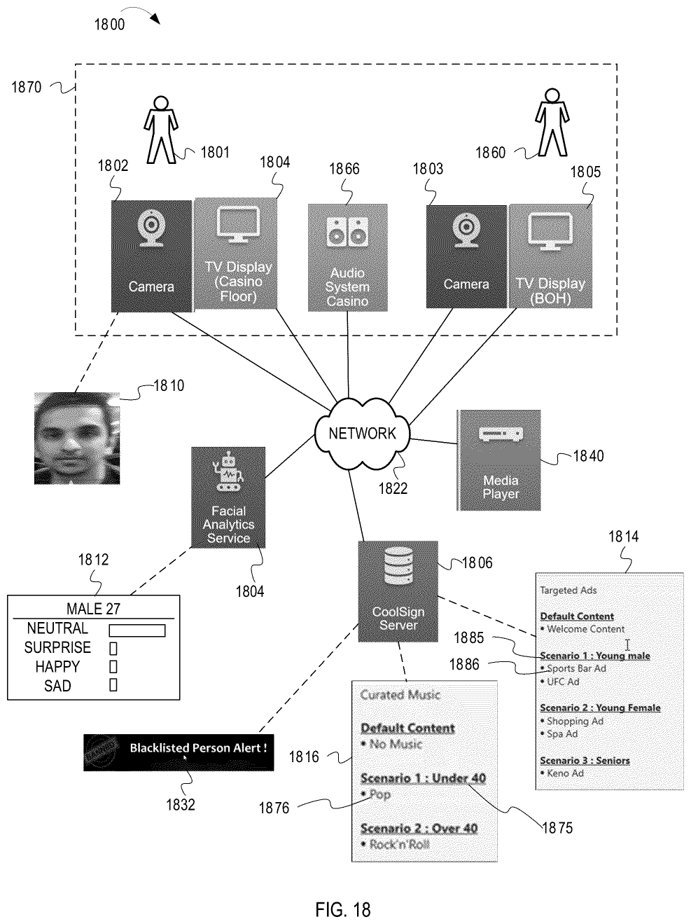

FIG. 18 is a diagram of a system 1800 in accordance with example embodiments of the present disclosure. The system 1800 includes a plurality of casino presentation devices, such as a network of displays (e.g., display 1804 and display 1805 connected via network 1822), and an audio system 1866 (e.g., a network of speakers). The architecture also includes a network of cameras (e.g., camera 1802 and camera 1803 connected via network 1822). Each one of the network of cameras is associated with a different one of the network of displays. Hence at least one camera is assigned to a respective node of a digital signage network. For instance, camera 1802 is attached to, or positioned near, display 1804, whereas camera 1803 is attached to, or positioned near, display 1805. The camera is positioned and angled so as to have an unobstructed view of facial features of a person that is viewing the associated display. In some embodiments, the camera is embedded into a frame of a display screen so as to face the direction of a viewer. In another embodiment, the position of the camera can be adjustable based on the on the placement of the display in the casino (or can automatically adjust in position relative to the display and/or rotate to have a different view). In one example, the camera may include settings that detect motion and which activate when a person is within sensing range. In another example, the camera runs continuously, such as a video camera that generates a continuous stream of images. The camera can be attached to a capture manager (e.g., see capture manager 453 in FIG. 4). In one embodiment, the capture manager is configured to capture a single frame of video (e.g., image 1810), crop images to contain only the face of one person, split up an single image of multiple people into multiple images of the different person's faces, modify screen resolutions to meet neural network input limits, modify images settings (e.g., modify contrast, colors, etc.), and so forth. In some embodiments, the capture manager 453 uses the data captured from the cameras to include in digital assets as described herein.

Furthermore, the network of cameras are connected to a facial analytics service 1804 via the network 1822. The facial analytics service 1804 is configured to analyze the images provided by the cameras (e.g., to analyze the image 1810). The facial analytics service 1804 uses a machine learning model configured to detect facial features and, based on the facial features, predict or determine the personal analytics information about a person in the images (e.g., determines personal analytics information 1812 from analysis of image 1810). Personal analytics information can include, but is not limited to, information that describes a person's identity, emotional state, demographics (e.g., approximate age, possible race, potential gender, etc.), or any other kind of information related to a person. Although identity is mentioned as one possible type of personal analytics information, the facial analytics service 1804 can also analyze images anonymously, without having to determine an identity of the person.

The system 1800 also includes a digital signage network server 1806 (e.g., a CoolSign™ server). The server 1806 receives, from the facial analytics service 1804, the personal analytics information. The server 1806 determines, based on the personal analytics information, specific content to present and from which of the casino presentation devices to present the content. For instance, the server 1806 stores different sets of criteria (e.g., targeted advertisement criteria 1814, curated music criteria 1816, blacklisted person criteria, etc.), which specify different types of content to present according to the specific classifications of determined personal analytics information. For instance, the server 1806 can determine, based on the personal analytics information whether to select content for presentation to the person in the analyzed image (e.g., the person 1801 that was in the image 1810) or to another person (e.g., to a casino employee 1860 located near the display 1805). For instance, the personal analytics information may include identity information about the person depicted in the image 1810. The server 1806 may determine, based on the identity information, that the person 1801 is banned from being in the casino area (i.e., blacklisted) or otherwise restricted (e.g., on watch-list, suspicious, etc.) If so, the server 1806 can generate an alert 1832 and direct the alert to the display 1805 so that the casino employee 1860 sees the alert 1832. On the other hand, if the server 1806 determines that the person is not restricted from being in the casino area 1870, then the server 1806 can determine (via the sets of criteria) to present specific content to display 1804 so that the person 1801 can view the content.

The system 1800 further includes a media player 1840 which is configured to determine which device (e.g., display, speaker, etc.) is in front of (or near) the targeted person, and then selects and presents the determined content from that device.

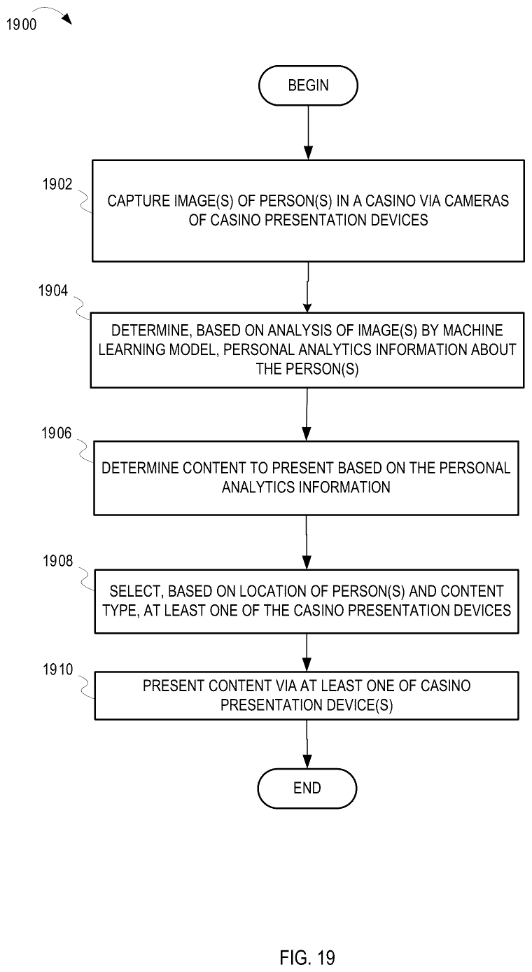

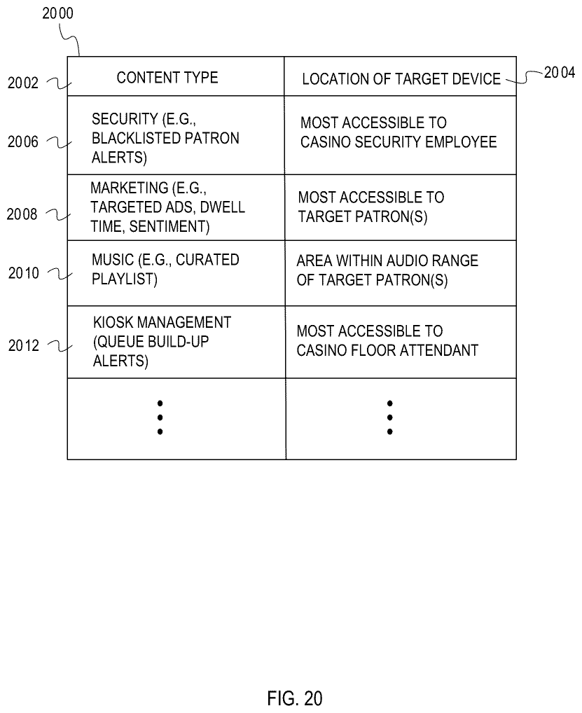

FIG. 19 is a flow diagram of a flow 1900 illustrating targeting content presentation in a casino environment in accordance with example embodiments of the present disclosure. FIG. 20 is a diagram associated with the data flow shown in FIG. 19 according to one or more embodiments of the present disclosure. FIG. 20 will be referenced in the description of FIG. 19. Furthermore, the flow 1900 will refer to a processor. It should be noted that the reference to the processor may refer to the same physical processor or it may be one of a set of a plurality of processors. The set of processors may operate in conjunction with each other and may be distributed across various networked devices. The types of processors may include a central processing unit, a graphics processing unit, any combination of processors, etc. In one embodiment, the processor may refer to the central processing unit (CPU) 2342 (FIG. 23) or a processor in another device mentioned herein.

Referring to FIG. 19, the flow 1900 begins at processing block 1902 where a processor captures, via cameras of (e.g., attached to) casino presentation devices, one or more images of a one or more persons in a casino. In one embodiment, the casino presentation devices include a digital signage network, such as the Bally CoolSign™ digital signage network. For instance, each node (e.g., display) of the digital signage network can have an associated camera. The camera is attached to, or near, the signage display. In at least some of the displays (e.g., displays positioned at a viewer's eye level, displays that are at ground level, etc.) the camera is attached to the display to have a head-on view of the person viewing the display. Because the displays are meant to present attractive content which will cause a user to look directly at the display, this allows for capture of a direct head-on image of the person. In some embodiments, for displays that are far away from a person and/or which are not at a general eye-level (e.g., overhead displays), a camera can be positioned relative to the display such that it will get a better image of the person (instead of being inside of, or right next to, the display).

The flow 1900 continues at processing block 1904 where a processor determines, based on analysis of the image(s) by a machine learning model, personal analytics information about the person(s). In one embodiment, the machine learning model includes a Convolutional Neural Network (CNN), such as the DeepFace Library (available at https://viso.ai/computer-vision/deepface/), FaceNet (available from Google LLC), DeepFace (available from Meta Platforms, Inc.), etc.

The flow 1900 continues at processing block 1906 where a processor determines content to present based on the personal analytics information. For instance, in one embodiment, the processor reads data from the personal analytics information and compares the data to similar data in criteria lists (e.g., lists 1814 and 1816). For instance, referring momentarily to FIG. 18, the image 1810 was analyzed and determined to have personal analytics information 1812 that indicates demographics of a person having an age (e.g., 27), a gender (e.g., male), and an emotional state (e.g., neutral). The different demographics are tags of information. The criteria 1816 includes a related, or similar tag of information that indicates a given age range 1875 (e.g., “under 40”). The age of the person (e.g., 27) falls within the age range 1875 (i.e., “under 40”). Thus, the server 1806 selects a designated type of content 1876 (e.g., “pop” music), which is listed under the matching age range 1875. Further, from criteria 1814, the server 1806 determines that the age of the person matches the tag for the age range 1885 (e.g., “young male”). Thus, the server 1806 selects the designated type of content 1886 (e.g., “sports bar ad” or “UFC ad”), which is listed under the matching age range 1885.

The flow 1900 continues at processing block 1908 where a processor selects, based on a location of the person(s) and a content type, at least one of the casino presentation devices. For instance, the processer determines which of the displays in a signage network are most accessible to either the person(s) whose image was captured or which are most accessible to a casino employee who needs to be made aware of the person(s). Furthermore, the processor further determines a content type. Content types include, but are not limited to, marketing content, music content, security content, kiosk management content, etc.

Referring momentarily to FIG. 20, the processor can refer to code, a list, a chart, etc. (e.g., chart 2000) that specifies a location 2004 for the device casino presentation device that should present the content, based on a content type 2002. For example, a first row 2006 of the chart 2000 indicates that if the content is security related, then the targeted device at which to present the security content (e.g., an alert) is a casino presentation device that is near a casino security employee (e.g., the server 1806 selects the display 1805, which is near the casino employee 1860). In some embodiments, the server 1806 can further query the network of cameras (including camera 1803) to capture images in the digital signage network until it finds (via analysis of the images by the facial analytics service 1804) an image of the casino employee 1860. The server 1860 determines that the camera 1803, at which the image of the casino employee 1860 was captured, is associated with the display 1805. Thus, the server 1806 determines that the security content (e.g., the alert 1832) is to be presented at the display 1805 so that the casino employee 1860 can see it. Furthermore, the server 1806 can determine to not present any security content to the display 1804. In some embodiments, the server 1806 can present content to the display 1804 that would cause the person(s) to move in a direction of the alerted casino employee.

Still referring to FIG. 20, a second row 2008 indicates that if the content is security related, then the targeted device at which to present the security content (e.g., an advertisement) is a casino presentation device that is near the person whose image was analyzed (e.g., as in FIG. 18, the server 1806 selects the display 1804, which is near the person 1801). The server 1806 can notify the media player 1840 to present advertising content to the display 1804 so that the person 1801 can see it.

Still referring to FIG. 20, a third row 2010 indicates that if the content is music-related, then the targeted device at which to present the music content includes casino speakers (e.g., from audio system 1866). A fourth row 2012 indicates that if the content is related to kiosk management (e.g., analysis of images taken of person(s) at a kiosk indicate that a queue build-up is occurring at the kiosk), then the location of the target casino presentation device includes, for instance, a display that is near and/or in line of sight with a casino floor attendant (e.g., to assist with the queue build up).

In some embodiments, the server 1806 can determine which of the casino presentation devices are “accessible to” or “most accessible to” a targeted person. The device that is “accessible” or “most accessible” may be determined according to specific factors such as, but are not limited to, the following: a location that a person is in relative to a camera (e.g., is the camera in front of the intended viewer or behind the intended viewer), a direction that a person is facing or moving relative to the camera, a camera that is most in-line with the intended viewer's visual perspective, a person's height, a camera's height (e.g., cameras at eye-level), a person's emotional state, a person's present actions (e.g., walking, sitting, eating, playing), etc.

Referring back to FIG. 19, the flow 1900 concludes at processing block 1910 where a processor presents the content via the at least one of the casino presentation devices. For example, as mentioned for FIG. 18, the server 1806 transmits instructions to the media player 1840 to select the appropriate content and to present it at the determined casino presentation device.

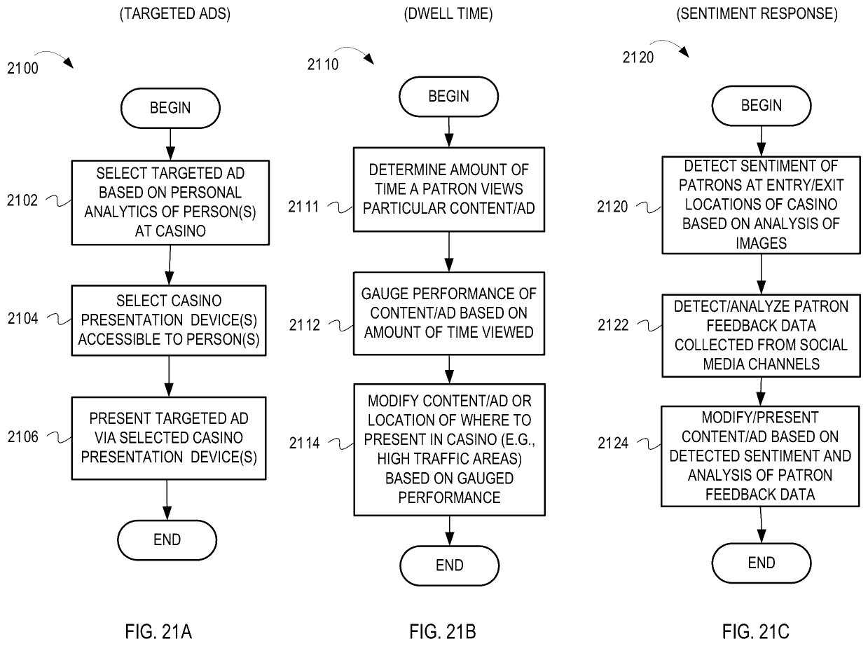

FIG. 21A is a flow diagram of a flow 2100 illustrating targeted marketing via a network of casino presentation devices in accordance with example embodiments of the present disclosure. For example, one or more processors (e.g., of system 1800) determine that the type of content described in FIG. 20 is a targeted advertisement. As a result, the flow 2100 begins at processing block 2102, where a processor selects targeted advertisement content based on personal analytics information of the person(s) whose images were analyzed in the casino. The flow 2100 continues at processing block 2104, where a processor selects a casino presentation device that is most accessible to the person(s). The flow 2100 continues at processing block 2106, where a processor (e.g., of media player 1840) presents the targeted advertisement at the casino presentation device that is most accessible to the person(s).

FIG. 21B is a flow diagram of a flow 2110 illustrating targeted marketing via a network of casino presentation devices in accordance with example embodiments of the present disclosure. For example, one or more processors (e.g., of the system 1800) determine that the type of content described in FIG. 20 is related to dwell-time. Dwell time is the total amount of time that a user stares at, or is otherwise focused on, a specific display, screen, section of content, etc. The flow 2110 begins a processing block 2111, where a processor determines an amount of time a patron views particular content or a part of the content. The flow 2110 continues at processing block 2112, where a processor gauges the performance of the content based on the amount of time viewed. The flow 2110 continues at processing block 2114, where a processor either modifies the content or modifies the location of where to present the content in a casino. For instance, the processor can remove or improve low performing content. Further, the processor can identify a more strategic location of the displays at which to display the content. In another embodiment, the processor can finding high traffic areas and can sent an alert to casino personnel to physically move more of the displays to those areas.

FIG. 21C is a flow diagram of a flow 2120 illustrating targeted marketing via a network of casino presentation devices in accordance with example embodiments of the present disclosure. For example, one or more processors (e.g., of system 1800) can determine that the type of content described in FIG. 20 is related to a sentiment of a group of people. For example, cameras at each entry/exit locations of a casino can capture images of people entering or leaving the property. The flow 2120 begins at processing block 2120, where a processor (e.g., of facial analytics service 1804) detects, based on analysis of images of people, an overall sentiment (e.g., average emotional state) of the patrons that enter or exit the casino. The flow continues at processing block 2122, where a processor detects and analyzes patron feedback data collected from social media channels. For instance, the processor can use information/data collected from a social media platform to detect what people are saying about the casino at any given time. The processor can, for example, parse through tweets about the property for certain key words that indicate an emotion or sentiment. The flow 2120 continues at processing block 2124, where a processor modifies or presents content based on the detected sentiment and based on the analysis of the patron feedback data.

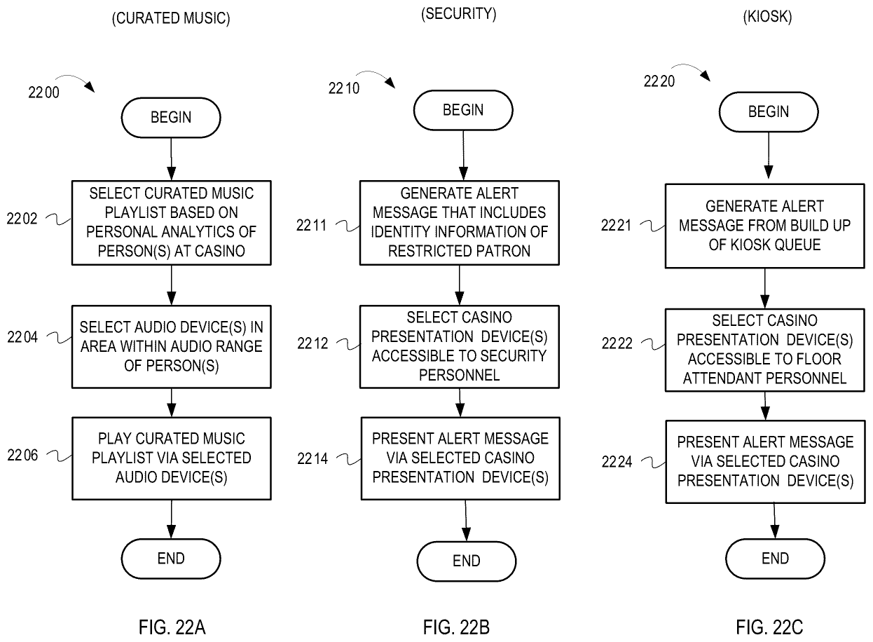

FIG. 22A is a flow diagram of a flow (2200) illustrating targeted casino operational content via a network of casino presentation devices in accordance with example embodiments of the present disclosure. For instance, casinos currently have to manually change play lists based on a manual inspection of the type of demographic in a casino. In contrast, in at least one embodiment, one or more processors (e.g., of system 1800) can automatically analyze images of a group of people within a given area of a casino, and curate a playlist for that particularly area based on an overall group demographic. For instance, the network of cameras captures floor data (e.g., takes images of the casino floor including the people and stores the images in a database, so that as more people populate the casino floor, the data grows). The facial analytics service 1804 determines personal analytics information for the group, which includes the number of people on the casino floor, and the demographic distribution of those people on the floor. The flow 2200 begins at processing block 2202, where a processor (e.g. of server 1806) selects a curated music playlist based on the personal analytics information of the group of people. For example, as mentioned, the server 1806 can select a music playlist listed in the criteria 1816 based on the overall group demographic. Furthermore, the server 1806 can use an API to select or create new playlists using an audio streaming platform (e.g., Spotify, Apple, Amazon music, etc.). The flow 2200 continues at processing block 2204, where a processor (e.g., of media player 1840) selects one or more audio devices within an area of the casino that is within audio range of the group of people. The flow 2200 continues at processing block 2206, where a processor (e.g., of media player 1840) plays the curated music playlist via the selected audio device(s).

FIG. 22B is a flow diagram of a flow (2210) illustrating targeted casino operational content via a network of casino presentation devices in accordance with example embodiments of the present disclosure. For example, one or more processors (e.g., of the system 1800) can be used for security purposes, such as to notify casino employees of a location and direction of a banned or restricted individual. The flow 2210 begins at processing block 2211, wherein the processor (e.g., of server 1806 or of media player 1840) generates an alert message that includes identity information of the individual. The flow 2210 continues at processing block 2212, where a processor (e.g., of media player 1840) selects the casino presentation device(s) that is/are most accessible to security personnel. In some embodiments, the processor determines, based on a location of the individual, which security employee (or specifically qualified employee) is closest to the location of the individual. The flow 2210 continues at processing block 2214, where a processor (e.g., of media player 1840) presents an alert message via the selected casino presentation device(s) (e.g., via display 1805). In some embodiments, the message may include all relevant data to identify the individual, such as a picture, a name, a description, etc. The message may also include a map to the location of the individual. In some embodiments, the message can be automatically sent to a mobile device of the security employee 1860, along with a copy of the map.

FIG. 22C is a flow diagram of a flow (2220) illustrating targeted casino operational content via a network of casino presentation devices in accordance with example embodiments of the present disclosure. For example one or more processors (e.g., of the system 1800) can further manage kiosks. For example, the system 1800 can detect, from cameras attached to a kiosk display, individuals in queue at a kiosk. The system 1800 detects a build-up of the queue. The flow 2220 begins at processing block 2221, where a processor (e.g., the system 1800) generates an alert message that indicates the build-up. The flow 2220 continues at processing block 2222, where a processor selects at least one casino presentation device that is most accessible (e.g., closest) to a floor attendant employee, or other such casino personnel. The flow 2220 continues at processing block 2224, wherein a processor presents the alert message via the at least one casino presentation device.

FIG. 23 is schematic view of a gaming system in accordance with example embodiments of the present disclosure. Referring to FIG. 23, a gaming machine 2310 includes game-logic circuitry 2340 (e.g., securely housed within a locked box inside a gaming cabinet). The game-logic circuitry 2340 includes a central processing unit (CPU) 2342 connected to a main memory 2344 that comprises one or more memory devices. The CPU 2342 includes any suitable processor(s), such as those made by Intel and AMD. By way of example, the CPU 2342 includes a plurality of microprocessors including a master processor, a slave processor, and a secondary or parallel processor. Game-logic circuitry 2340, as used herein, comprises any combination of hardware, software, or firmware disposed in or outside of the gaming machine 2310 that is configured to communicate with or control the transfer of data between the gaming machine 2310 and a bus, another computer, processor, device, service, or network. The game-logic circuitry 2340, and more specifically the CPU 2342, comprises one or more controllers or processors and such one or more controllers or processors need not be disposed proximal to one another and may be located in different devices or in different locations. The game-logic circuitry 2340, and more specifically a main memory 2344, comprises one or more memory devices which need not be disposed proximal to one another and may be located in different devices or in different locations. The game-logic circuitry 2340 is operable to execute all of the various gaming methods and other processes disclosed herein. The main memory 2344 includes a wagering-game unit 2346. In one embodiment, the wagering-game unit 2346 causes wagering games to be presented, such as video poker, video blackjack, video slots, video lottery, etc., in whole or part.

The game-logic circuitry 2340 is also connected to an input/output (I/O) bus 2348, which can include any suitable bus technologies, such as an AGTL+ frontside bus and a PCI backside bus. The I/O bus 2348 is connected to various input devices 2350, output devices 2352, and input/output devices 2354.

By way of example, the output devices may include a primary display, a secondary display, and one or more audio speakers. The primary display or the secondary display may be a mechanical-reel display device, a video display device, or a combination thereof in which a transmissive video display is disposed in front of the mechanical-reel display to portray a video image superimposed upon the mechanical-reel display. The displays variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 2310. The gaming machine 2310 can also include a touch screen(s) mounted over the primary or secondary displays, buttons on a button panel, a bill/ticket acceptor, a card reader/writer, a ticket dispenser, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen, buttons, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

The input/output devices 2354 include one or more value input/payment devices and value output/payout devices. In order to deposit cash or credits onto the gaming machine 2310, the value input devices are configured to detect a physical item associated with a monetary value that establishes a credit balance on a credit meter (e.g., credit meter 420 described in FIG. 10). The physical item may, for example, be currency bills, coins, tickets, vouchers, coupons, cards, and/or computer-readable storage mediums. The deposited cash or credits are used to fund wagers placed on the wagering game played via the gaming machine 2310. Examples of value input devices include, but are not limited to, a coin acceptor, a bill/ticket acceptor (e.g., a bill validator), a card reader/writer, a wireless communication interface (e.g., wireless communication device 102) for reading cash or credit data from a nearby mobile device, and a network interface for withdrawing cash or credits from a remote account via an electronic funds transfer. In response to a cashout input that initiates a payout from the credit balance on the “credits” meter the value output devices are used to dispense cash or credits from the gaming machine 2310. The credits may be exchanged for cash at, for example, a cashier or redemption station. Examples of value output devices include, but are not limited to, a coin hopper for dispensing coins or tokens, a bill dispenser, a card reader/writer, a ticket dispenser for printing tickets redeemable for cash or credits, a wireless communication interface for transmitting cash or credit data to a nearby mobile device, and a network interface for depositing cash or credits to a remote account via an electronic funds transfer.

The I/O bus 2348 is also connected to a storage unit 2356 and an external-system interface 2358, which is connected to external system(s) 2360 (e.g., wagering-game networks, communications networks, etc.).

The external system(s) 2360 includes, in various aspects, a gaming network, other gaming machines or terminals, a gaming server, a remote controller, communications hardware, or a variety of other interfaced systems or components, in any combination. In yet other aspects, the external system(s) 2360 comprises a player's portable electronic device (e.g., cellular phone, electronic wallet, etc.) and the external-system interface 2358 is configured to facilitate wireless communication and data transfer between the portable electronic device and the gaming machine 2310, such as by a near-field communication path operating via magnetic-field induction or a frequency-hopping spread spectrum RF signals (e.g., Bluetooth, etc.).

The gaming machine 2310 optionally communicates with the external system(s) 2360 such that the gaming machine 2310 operates as a thin, thick, or intermediate client. The game-logic circuitry 2340—whether located within (“thick client”), external to (“thin client”), or distributed both within and external to (“intermediate client”) the gaming machine 2310—is utilized to provide a wagering game on the gaming machine 2310. In general, the main memory 2344 stores programming for a random number generator (RNG), game-outcome logic, and game assets (e.g., art, sound, etc.)—all of which obtained regulatory approval from a gaming control board or commission and are verified by a trusted authentication program in the main memory 2344 prior to game execution. The authentication program generates a live authentication code (e.g., digital signature or hash) from the memory contents and compares it to a trusted code stored in the main memory 2344. If the codes match, authentication is deemed a success and the game is permitted to execute. If, however, the codes do not match, authentication is deemed a failure that must be corrected prior to game execution. Without this predictable and repeatable authentication, the gaming machine 2310, external system(s) 2360, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 2342 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 2342 when executing the game-outcome logic to determine a resultant outcome for that instance of the wagering game. The resultant outcome is then presented to a player of the gaming machine 2310 by accessing the associated game assets, required for the resultant outcome, from the main memory 2344. The CPU 2342 causes the game assets to be presented to the player as outputs from the gaming machine 2310 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player, for example, at a minimum of 100 Hz (100 calls per second) as set forth in Nevada's New Gaming Device Submission Package. Accordingly, the RNG cannot be carried out manually by a human and is integral to operating the game.

The gaming machine 2310 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 2310 may include additional peripheral devices or more than one of each component shown in FIG. 23. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

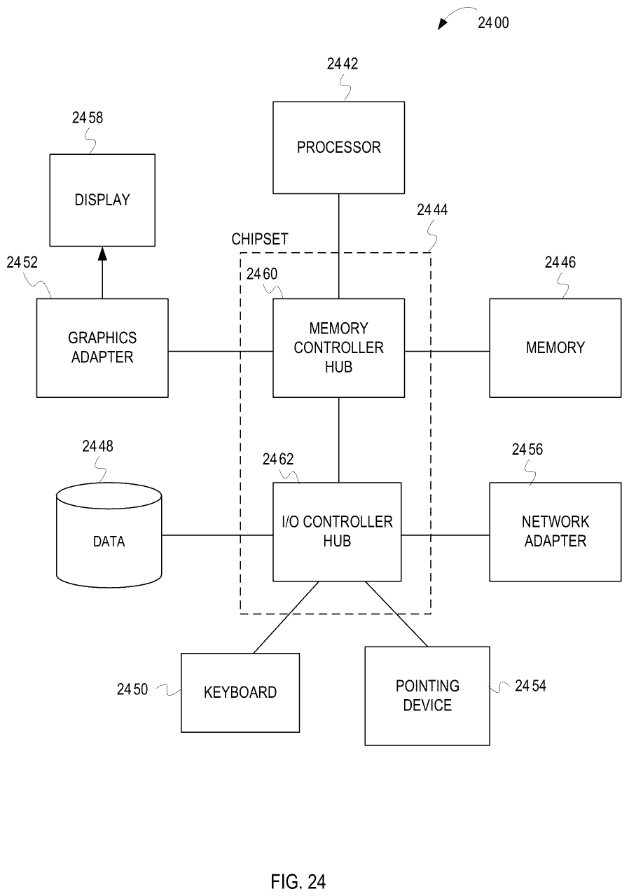

FIG. 24 is shown a diagram of a computer system 2400 in accordance with example embodiments of the present disclosure. The computer system 2400 includes at least one processor 2442 coupled to a chipset 2444, as indicated in dashed lines. Also coupled to the chipset 2444 are memory 2446, a storage device 2448, a keyboard 2450, a graphics adapter 2452, a pointing device 2454, and a network adapter 2456. A display 2458 is coupled to the graphics adapter 2452. In one embodiment, the functionality of the chipset 2444 is provided by a memory controller hub 2460 and an I/O controller hub 2462. In another embodiment, the memory 2446 is coupled directly to the processor 2442 instead of to the chipset 2444.

The storage device 2448 is any non-transitory computer-readable storage medium, such as a hard drive, a compact disc read-only memory (CD-ROM), a DVD, or a solid-state memory device (e.g., a flash drive). The memory 2446 holds instructions and data used by the processor 2442. The pointing device 2454 may be a mouse, a track pad, a track ball, or another type of pointing device, and it is used in combination with the keyboard 2450 to input data into the computer system 2400. The graphics adapter 2452 displays images and other information on the display 2458. The network adapter 2456 couples the computer system 2400 to a local or wide area network.

As is known in the art, the computer system 2400 can have different and/or other components than those shown in FIG. 24. In addition, the computer system 2400 can lack certain illustrated components. In one embodiment, the computer system 2400 acting as the moment control system 170 (FIG. 1) may lack the keyboard 2450, pointing device 2454, graphics adapter 2452, and/or display 2458. Moreover, the storage device 2448 can be local and/or remote from the computer system 2400 (such as embodied within a storage area network (SAN)). Moreover, other input devices, such as, for example, touch screens may be included.

The network adapter 2456 (may also be referred to herein as a communication device) may include one or more devices for communicating using one or more of the communication media and protocols discussed herein.

In addition, some or all of the components of this general computer system 2400 of FIG. 24 may be used as part of the processor and memory discussed above with respect to the systems or devices described herein.

In some embodiments, a gaming system may comprise several such computer systems 2400. The gaming system may include load balancers, firewalls, and various other components for assisting the gaming system to provide services to a variety of user devices.

The computer system 2400 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 2448, loaded into the memory 2446, and executed by the processor 2442.

FIG. 2, FIG. 3, FIG. 10, FIG. 11A, FIG. 11B, FIG. 14, FIG. 15, FIG. 16, FIG. 17, FIG. 19, FIG. 21A, FIG. 21B, FIG. 21C, FIG. 22A, FIG. 22B, or FIG. 22C described by way of example above, represent data processing methods (e.g., algorithms) that correspond to at least some instructions stored and executed by a processor and/or logic circuitry associated with the moment control system 170. However other embodiments can utilize processors and/or logic circuitry of any of the devices described for FIG. 2, FIG. 3, FIG. 10, FIG. 11A, FIG. 11B, FIG. 14, FIG. 15, FIG. 16, FIG. 17, FIG. 19, FIG. 21A, FIG. 21B, FIG. 21C, FIG. 22A, FIG. 22B, or FIG. 22C to perform the above described functions associated with the disclosed concepts.

Any component of any embodiment described herein may include hardware, software, or any combination thereof.

Further, the operations described herein can be performed in any sensible order. Any operations not required for proper operation can be optional. Further, all methods described herein can also be stored as instructions on a computer readable storage medium, which instructions are operable by a computer processor. All variations and features described herein can be combined with any other features described herein without limitation. All features in all documents incorporated by reference herein can be combined with any feature(s) described herein, and also with all other features in all other documents incorporated by reference, without limitation.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the claimed subject matter, including the best mode, and also to enable any person skilled in the art to practice the claimed subject matter, including making and using any devices or systems and performing any incorporated methods. The patentable scope of the disclosed technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method comprising:
detecting, by a processor of a gaming system, a qualifying game event for a sharable gaming moment;
in response to detecting the qualifying game event, generating, by the processor, a digital asset, wherein the digital asset indicates details of the qualifying game event;
encoding, by the processor, a referral code with the digital asset;
transmitting, in response to a user input via an application of a user computing device, the digital asset and the referral code to at least one gaming channel;
detecting, in response to electronic communication from the at least one gaming channel, an action associated with the digital asset; and
in response to detecting the action, awarding, by the processor based on the referral code, a number of points for use via the gaming system.

2. The method of claim 1 further comprising:
capturing, via one or more moment capture devices of the gaming system, content depicting a physical gaming environment during the qualifying game event; and
incorporating, by the processor, the content into the digital asset prior to transmitting the digital asset and the referral code.

3. The method of claim 1, further comprising:
detecting, in response to additional user input via the application, a customization of the digital asset prior to transmitting the digital asset and the referral code.

4. The method of claim 3, wherein the gaming system is communicatively connected to a blockchain platform via a network, said method further comprising:
minting, by the processor via the blockchain platform, the digital asset as a nonfungible token (NFT);
storing the referral code in a smart contract of the NFT, wherein a smart-contract code is associated with the referral code and with an indication for the action in the smart contract; and
listing, via the application, the NFT with an NFT marketplace.

5. The method of claim 4, further comprising:
detecting, by the blockchain platform via electronic communication with the NFT marketplace, occurrence of the action in association with use of the NFT via the NFT marketplace; and
executing the smart-contract code, wherein the executing the smart contract code generates a message that indicates the referral code and the action; and
wherein the awarding is in response to receiving the message by the gaming system.

6. The method of claim 3, further comprising:
detecting, in response to selection of an input control via the application, a purchase of the digital asset prior to customization of the digital asset;
customizing an appearance of the digital asset based on the additional input; and
after customizing the appearance of the digital asset, listing, via the at least one gaming channel, the digital asset for sale.

7. The method of claim 6, further comprising:
detecting, as the action of the digital asset, a sale of the listed digital asset via the at least one gaming channel; and
in response to detecting the sale of the listed digital asset, awarding the number of points.

8. The method of claim 7, wherein the purchase of the digital asset is from a casino account, and wherein the sale of the listed digital asset is to the casino account, and wherein the awarding the number of points is based on one of more of the purchase from the casino account or the sale to the casino account.

9. The method of claim 3 further comprising:
determining a subscription level, of a user account associated with the user computing device; and
unlocking, via the application, a set of customization tools based on the subscription level.

10. The method of claim 1, wherein awarding the number of points based on the referral code in association with the action comprises determining the number of points based on a type or level of the action.

11. The method of claim 1, wherein the transmitting the digital asset comprises livestreaming, via a livestreaming service connected to the gaming system via a network, the digital asset, wherein detecting the use of the referral code comprises detecting a number of subscriptions that occurred during the livestreaming in association with the referral code, and wherein the awarding the number of points is based on the number of subscriptions.

12. A gaming system comprising:
a network interface device; and
an electronic processor, said electronic processor having instructions stored thereon which, when executed by the processor, cause the gaming system to perform operations to:
detect a qualifying game event for a sharable gaming moment;
in response to detection of the qualifying game event, generate a digital asset that indicates details of the qualifying game event;
encode a referral code with the digital asset;
transmit, in response to a user input via an application of a user computing device, the digital asset and the referral code to at least one gaming channel;
detect, in response to electronic communication from the at least one gaming channel, action associated with the digital asset; and
in response to detection of the action, award, based on the referral code in association with the action, a number of points for use.

13. The gaming system of claim 12, wherein the stored instructions include instructions which, when executed by the electronic processor, cause the gaming system to perform operations to:
capture, via one or more moment capture devices, content depicting a physical gaming environment during the qualifying game event; and
incorporate the content into the digital asset prior to transmission of the digital asset and the referral code.

14. The gaming system of claim 13, wherein the stored instructions include instructions which, when executed by the electronic processor, cause the gaming system to perform operations to:
detect, in response to additional user input via the application, a customization of the digital asset.

15. The gaming system of claim 14, wherein the gaming system is communicatively connected to a blockchain platform via a network, and wherein the stored instructions include instructions which, when executed by the electronic processor, cause the gaming system to perform operations to:
mint, via the blockchain platform, the digital asset as a nonfungible token (NFT);
store the referral code in a smart contract of the NFT, wherein a smart-contract code is associated with the referral code and with an indication for the action in the smart contract; and
list, via the application, the NFT with an NFT marketplace.

16. The gaming system of claim 15, wherein the stored instructions include instructions which, when executed by the electronic processor, cause the gaming system to perform operations to:
detect, by the blockchain platform via electronic communication with the NFT marketplace, occurrence of the action in association with use of the NFT via the NFT marketplace; and
execute the smart-contract code, wherein execution of the smart contract code generates a message that indicates the referral code and the action; and
wherein awarding the points is in response to receipt of the message via a bonusing system.

17. The gaming system of claim 14, wherein the stored instructions include instructions which, when executed by the electronic processor, cause the gaming system to perform operations to:
detect, in response to selection of an input control via the application, a purchase of the digital asset prior to customization of the digital asset;
customize an appearance of the digital asset based on the additional input; and
after customization of the appearance of the digital asset, list, via the at least one gaming channel, the digital asset for sale.

18. The gaming system of claim 17, wherein the stored instructions include instructions which, when executed by the electronic processor, cause the gaming system to perform operations to:
detect, as the action of the digital asset, a sale of the listed digital asset via the at least one gaming channel; and
in response to detection of the sale of the listed digital asset, award the number of points.

19. The gaming system of claim 18, wherein the purchase of the digital asset is from a casino account, and wherein the sale of the listed digital asset is to the casino account, and wherein awarding the number of points is based on both the purchase from the casino account and the sale to the casino account.

20. The gaming system of claim 19, wherein the stored instructions include instructions which, when executed by the electronic processor, cause the gaming system to perform operations to:
determine a level associated with a user account, wherein the user account is associated with the user computing device; and
unlock, via the application, a set of customization tools based on the level.

21. The gaming system of claim 20, wherein the level is based on one or more of an account status, a subscription level, or an earned benefit of the user account.
